(19) United States
(12) Patent Application Publication
(10) Pub. No.: US 2014/0014214 A1
(43) Pub. Date: Jan. 16, 2014

(54) Multiple Process Service Vessel

(71) Applicants: Jan Thore Eia, Kvernalang (NO); Paal Helmichsen, Sola (NO); Peter John Wright, Hundvag (NO)

(72) Inventors: Jan Thore Eia, Kvernalang (NO); Paal Helmichsen, Sola (NO); Peter John Wright, Hundvag (NO)

(21) Appl. No.: 13/497,695

(22) PCT Filed: Sep. 24, 2010
(86) PCT No.: PCT/IB2010/002503

§ 371 Date: Aug. 23, 2013

Related U.S. Application Data
(60) Provisional application No. 61/245,807, filed on Sep. 25, 2009.

(51) Int. Cl. F17D 1/08

(52) U.S. Cl. CPC F17D 1/08
USPC 137/899.2

(57) ABSTRACT

A multiple process service vessel including a first module configured to mix drilling fluids and a second module configured to remediate drilling waste, wherein the first and second modules are located at least partially below the deck of the vessel. A method of processing drilling components, the method including transferring a first drilling fluid component from a pressurized vessel on a multiple process service vessel to a mixing unit at a first location; mixing the first drilling fluid component with a second drilling fluid component in the mixing unit to produce a drilling fluid; transferring the drilling fluid to a second pressurized vessel; moving the multiple process service vessel to a second location; and transferring the drilling fluid from the second pressurized vessel to a drilling location.

### BACKGROUND

1. Field of the Disclosure

Embodiments disclosed herein relate generally to apparatuses and methods for processing drilling fluid and waste components on a multiple purpose service vessel. More specifically, embodiments disclosed herein relate to apparatuses and methods for processing drilling waste and building drilling fluids on a multiple purpose service vessel. More specifically still, embodiments disclosed herein relate to apparatuses and methods for remediating drilling waste from drilling operations and using the remediated waste in other drilling operations.

2. Background Art

In the drilling of wells, a drill bit is used to dig many thousands of feet into the earth's crust. Oil rigs typically employ a derrick that extends above the well drilling platform. The derrick supports joint after joint of drill pipe connected end-to-end during the drilling operation. As the drill bit is pushed further into the earth, additional pipe joints are added to the ever lengthening “string” or “drill string”. Therefore, the drill string typically includes a plurality of joints of pipe.

Fluid “drilling mud” is pumped from the well drilling platform, through the drill string, and to a drill bit supported at the lower or distal end of the drill string. The drilling mud lubricates the drill bit and carries away well cuttings generated by the drill bit as it digs deeper. The cuttings are carried in a return flow stream of drilling mud through the well annulus and back to the well drilling platform at the earth's surface. When the drilling mud reaches the platform, it is contaminated with small pieces of shale and rock that are known in the industry as well cuttings or drill cuttings. Once the drill cuttings, drilling mud, and other waste reach the platform, a “shale shaker” is typically used to remove the drilling mud from the drill cuttings so that the drilling mud may be reused. The remaining drill cuttings, waste, and residual drilling mud are then transferred to a holding trough for disposal. In some situations, for example with specific types of drilling mud, the drilling mud may not be reused and it must also be disposed. Typically, the non-recycled drilling mud is disposed of separate from the drill cuttings and other waste by transporting the drilling mud via a vessel to a disposal site.

In offshore drilling, the drilling waste is either processed at the rig, or otherwise returned to shore for disposal. Space on offshore platforms is limited. In addition to the storage and transfer of cuttings, many additional operations take place on a drilling rig, including tank cleaning, slurrification operations, drilling, chemical treatment operations, raw material storage, mud preparation, mud recycle, mud separations, and many others.

Due to the limited space, it is common to modularize these operations and to swap out modules when not needed or when space is needed for the equipment. In order to swap out such equipment, supply vessels are used to transport specific types of equipment from shore to the offshore rigs. The lifting operations required to swap modular systems, as mentioned above, may be difficult, dangerous, and expensive. Additionally, many of these modularized operations are self-contained, and therefore include redundant equipment, such as pumps, valves, and tanks or storage vessels.

The supply vessels are also used to resupply offshore rigs with supplies for mixing drilling fluids, or to otherwise ship provisions to the offshore rigs. Use of such supply vessels often require multiple trips to and from shore, and do to the limited modularity of the supply vessels, the operation are redundant and often expensive.

Accordingly, there is a continuing need for supply vessels capable of processing drilling waste and building drilling fluids for offshore drilling and production operations.

### SUMMARY OF THE DISCLOSURE

In one aspect, embodiments disclosed herein relate to a multiple process service vessel including a first module configured to mix drilling fluids and a second module configured to remediate drilling waste, wherein the first and second modules are located at least partially below the deck of the vessel.

In another aspect, embodiments disclosed herein relate to a multiple process service vessel including a plurality of pressurized vessels; a first module in fluid communication with the plurality of pressurized vessels, the first module including a drilling fluid mixer; a second module in fluid communication with the plurality of pressurized vessels, the second module including a drilling waste remediation unit; a third module in fluid communication with the plurality of pressurized vessels, the third module including an automatic tank cleaning unit; a fourth module in fluid communication with the plurality of pressurized vessels, the fourth module including an environmental remediation unit, wherein the first, second, third, and fourth modules are located below a deck of the multiple process service vessel.

In yet another aspect, embodiments disclosed herein relate to a method of processing drilling components, the method including transferring a first drilling fluid component from a pressurized vessel on a multiple process service vessel to a mixing unit at a first location; mixing the first drilling fluid component with a second drilling fluid component in the mixing unit to produce a drilling fluid; transferring the drilling fluid to a second pressurized vessel; moving the multiple process service vessel to a second location; and transferring the drilling fluid from the second pressurized vessel to a drilling location.

In another aspect, embodiments disclosed herein related to a method of processing drilling components, the method including transferring drilling waste from a drilling location to a multiple process service vessel; processing the drilling waste into a fluid component and a waste component; adjusting at least one property of the fluid component; and transferring the fluid component to a storage vessel on the multiple process service vessel.

Other aspects and advantages of the invention will be apparent from the following description and the appended claims.

### BRIEF DESCRIPTION OF DRAWINGS

FIG. 1 is a partial cross-section of a multiple purpose service vessel according to embodiments of the present application.

FIG. 2 is a partial cross-section representation of a multiple purpose service vessel according to embodiments of the present application.

FIG. 3 is a partial cross-section representation of a multiple purpose service vessel according to embodiments of the present application.

FIGS. 4-6 are various views of pressurized vessels according to embodiments of the present application.

FIG. 7 is a perspective view of a pressurized transference device according to embodiments of the present application.

FIG. 8-11 are various views of tank cleaning units according to embodiments of the present application.

FIGS. 12-15 are various views of slurrification units according to embodiments of the present application.

FIGS. 16-19 are various views of environmental units according to embodiments of the present application.

### DETAILED DESCRIPTION

In one aspect, embodiments disclosed herein relate generally to apparatuses and methods for processing drilling fluid and waste components on a multiple purpose service vessel. More specifically, embodiments disclosed herein relate to apparatuses and methods for processing drilling waste and building drilling fluids on a multiple purpose service vessel. More specifically still, embodiments disclosed herein relate to apparatuses and methods for remediating drilling waste from drilling operations and using the remediated waste in other drilling operations.

Typically in offshore drilling operations a drilling rig or platform is supplied, resupplied, or serviced, throughout drilling and production operations by supply vessels. Such supply vessels transport materials between onshore locations and the drilling rigs. Examples of materials that may be transported include based drilling fluid components, such as base oil, water, chemicals, weighting agents, and the like. Other materials that may be transported include fuel, such as diesel, heavy oil, or other components used to run a drilling or production operation. During drilling or production operations, the operations may also produce waste that may not be disposable at the rig location. In such cases, supply vessels may be used to transport waste from the drilling or production operation back to shore, whereafter the waste may be processed.

Each of the supply vessels typically have a single purpose. For example, a supply vessel may be capable of transporting specific types of fluids, solids, waste products, etc. Thus, during a drilling and production operation, multiple supply vessels may be transporting material to and from the drilling operation at any given time.

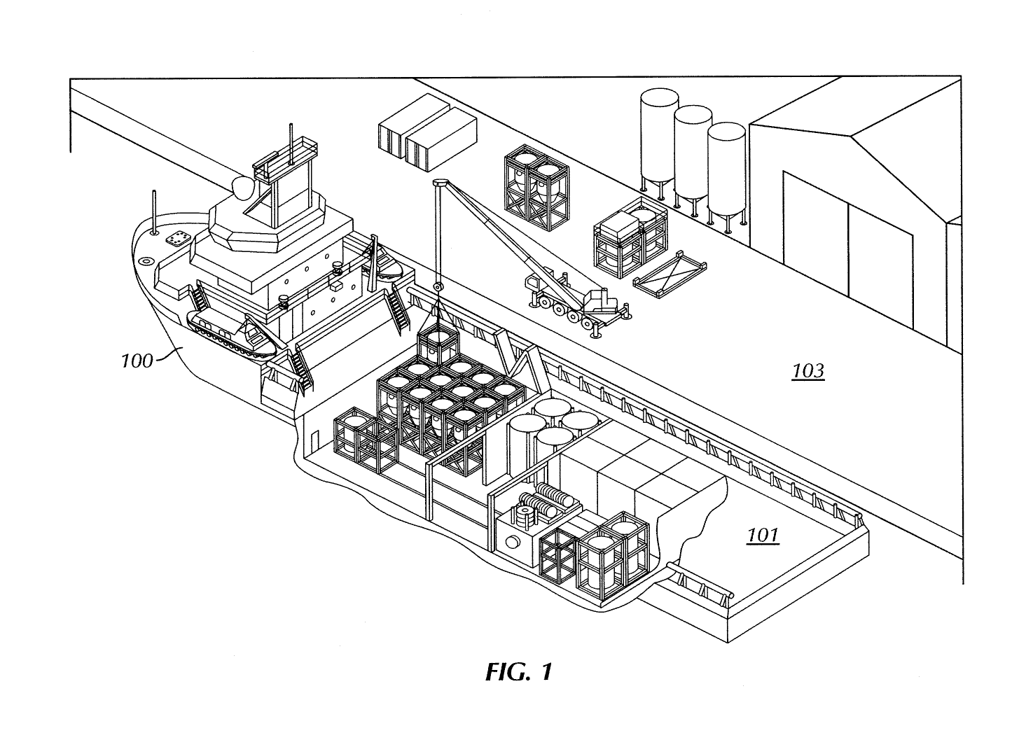

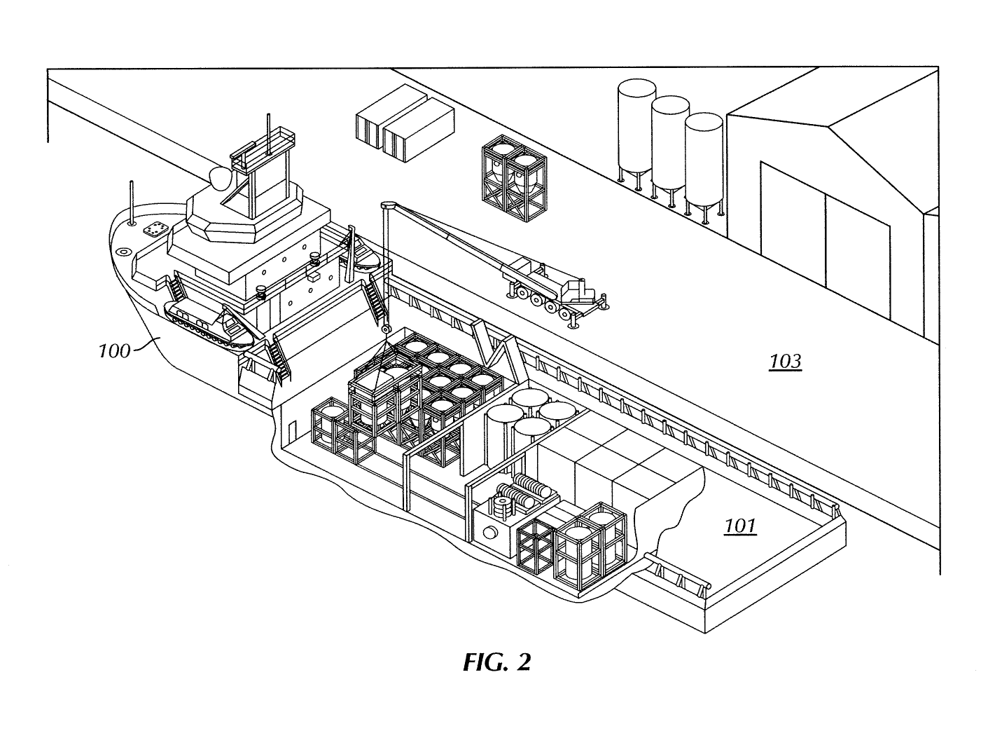

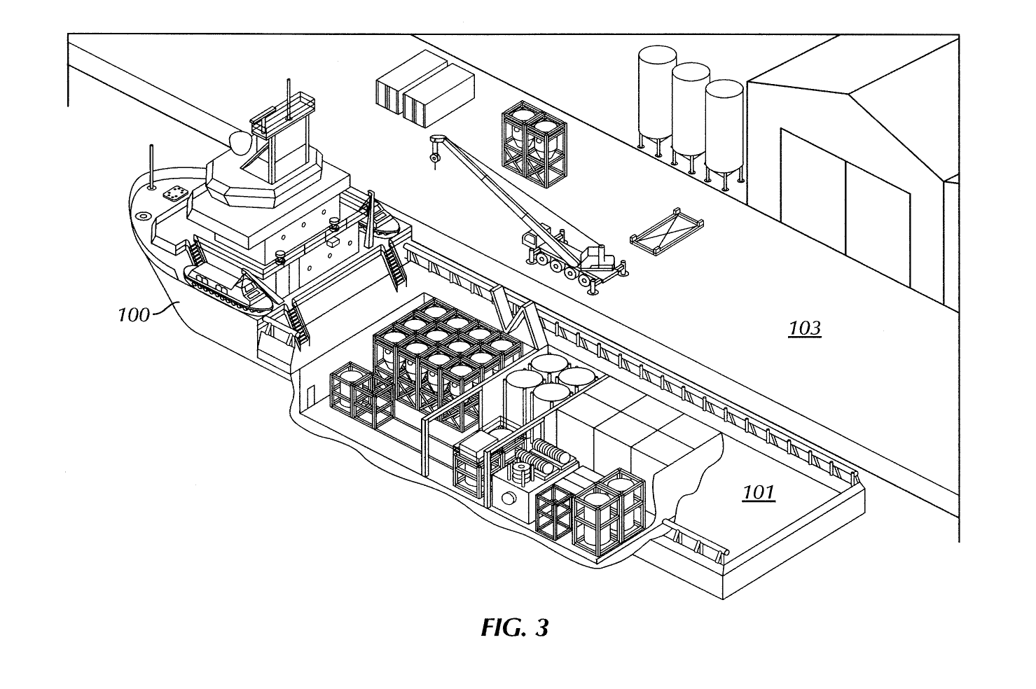

Embodiments of the present disclosure provide multiple process supply vessels capable of performing multiple maintenance operations to support offshore drilling and production operations. Referring initially to FIGS. 1-3, a partial cross-sections of a multiple process supply vessel according to embodiments of the present application is shown. FIGS. 1-3 illustrate the various stages of loading components from an onshore facility 103 onto a multiple process supply vessel 100. Specifically, FIG. 1 shows components on the dock, prior to being loaded, FIG. 2 shows components being loaded by crane 21 onto multiple process supply vessel 100, and FIG. 3 shows multiple process supply vessel 100 loaded with multiple types of components. The individual components and modules resulting from various combinations of components will be discussed in detail below. Those of ordinary skill in the art will appreciate that in other embodiments, components may be loaded in ways other than via crane 21. For example, in certain embodiments, the components may be loaded by a crane (not shown) on multiple process supply vessel 100, may be loaded with forklifts, or via other components transfer apparatuses. In certain embodiments, the components may not require transfer from onshore facility 103, as the components may be permanently installed on multiple process supply vessel 100.

Referring specifically to FIG. 3, multiple process supply vessel 100 is illustrated docked at onshore loading facility 103. Examples of components that may be loaded or unloaded onto or off of multiple process supply vessel 100 include pressurized storage vessels 1, surge tanks 2, hoppers 3, and mixers 4. Such components may be used in drilling fluid mixing and/or reconstitution operations, which will be discussed in detail below. Other types of components that may be on multiple process supply vessel 100 include components for drilling waste remediation, such as, for example, separators 15 and 16, which in this embodiment are a centrifuge 15 and dryer 16, respectively. Other drilling waste remediation components may include effluent tank 17, automatic tank cleaning unit 14, and environmental unit 13. In certain aspects, automatic tank cleaning unit 14 and environmental unit 13 may be used in more than just waste remediation operations. For example, the units may be used to clean other components on multiple process supply vessel 100, such as, for example, pressurized vessels 1. Other components that may be on multiple process supply vessel 100 include storage vessels 5-12 used to store, for example, bentonite, barite, cement, water, diesel, base oil, brine, slop, or other components of drilling fluid or waste. The drilling fluid and waste components may also be stored in pressurized vessels 1, depending on the type of material and/or the type of operations being performed at the drilling or production rig.

In addition to multiple process supply vessel 100 being able to store multiple components for drilling fluid mixing and waste remediation, the location of the components on multiple process supply vessel 100 may be advantageous. As illustrated, the components are housed below the deck 201 of multiple process supply vessel 100. In order to allow the components to be loaded or unloaded from multiple process supply vessel 100, retractable hatch covers 20 may be moved, thereby allowing, for example, a crane 21 to remove or place components from or onto the multiple process supply vessel 100. Those of ordinary skill in the art will appreciate that multiple types of hatch covers 20 may be used. For example, as illustrated, the hatch covers 20 may be foldable, or in other embodiments, the hatch covers 20 may be removable, slidable, hinged, or otherwise displaceable so as to allow component placement or removal below deck 201.

Multiple process supply vessel 100 may also be equipped with module rolltracks 18 and/or rolling decks 19, thereby allowing components to be moved inside multiple process supply vessel 100. For example, during a loading operation, crane 21 may lift a component below deck 101 by folding hatch cover 20 as illustrated in FIG. 3. The component may be placed on rolltracks 18, and thereafter slide into position, as illustrated in the progression of FIGS. 1 through 3. As such, multiple process supply vessel 100 may only require a small portion of deck 101 to include folding hatch covers 20. In still other embodiments, multiple process supply vessel 100 may have multiple section of the vessel that provide access below deck 101, thereby allowing multiple cranes 21 to load and/or unload components from multiple process supply vessel 100.

Multiple process supply vessel 100 may provide various support functions to offshore drilling and/or production rigs. For example, multiple process supply vessel 100 may be used to transfer components of drilling fluids, mix drilling fluids, remediate drilling fluids, transfer drilling fluids, transfer drilling waste, remediate drilling waste, generate reinjection slurries, and transfer reinjection slurries. Those of ordinary skill in the art will appreciate that multiple process supply vessel 100 may also provide other various functions not explicitly listed in this disclosure. Each of the above functions may be performed by various combinations of components, which will be discussed in detail below. Generally, multiple process supply vessel 100 may include modules for generating, building, and transferring drilling fluids and remediating, slurrifying, and transferring drilling waste. More specifically, multiple process supply vessel 100 may include a first module configured to mix drilling fluids and a second module configured to remediate drilling waste. Those of ordinary skill in the art will appreciate that reference to first and second modules do not refer to explicit combinations of components, as individual components may be used in both modules, or in certain applications, components may exist outside the scope of either module. Thus, the first and second modules refer to the function of a group of components to perform a particular operation, namely, mixing drilling fluids and/or remediating waste.

A drilling fluid module primarily refers to components used in the building or reprocessing of drilling waste, and may include, for example, pressurized vessels 1, surge tank 2, hopper 3, mixer 4, and other storage vessels 5-12 that may be used to supply drilling fluid components or hold mixed drilling fluid. A drilling waste module primarily refers to components used in remediating drilling fluid or producing slurries, and may include, for example, pressurized vessels 1, separators 15 and 16, effluent tank 17, and other various storage vessels that may be used to store waste prior to processing or store products generated during remediation or slurrification.

In one embodiment, multiple process supply vessel 100 may include one or more pressurized vessels 1 in fluid communication with one or more of the drilling fluid module or the waste module. Specific types of pressurized vessels 1 will be described below, but generally, pressurized vessels 1 may allow for the transference of solids and liquids between various components of the system, and may provide the function of long term storing, mixing, or serve as an intermediary holding tank for other aspects of modules of the operation. Pressurized vessels 1 may be in fluid communication with a surge tank 2, which may be a pressurized tank capable of releasing contents therefrom. Surge tank 2 may be in fluid communication with hopper 3, which is likewise in fluid communication with mixer 4.

A drilling fluid module that may be used in building new fluids may involve the transference of drilling fluid components, such as, for example, weighting agents, chemicals, or other dry materials to surge tank 2. The dry components may then be dispensed into hopper 3, whereby a liquid drilling fluid component is introduced. Liquid drilling fluid components may include, for example, water, brine, or recycled drilling fluids from pressurized vessel 1 or other storage tanks 5-12. The dry and liquid components are then combined while being transferred to mixer 4. After the dry and liquid components are mixed, the resultant drilling fluid may be transferred to a storage vessel 5-12 or a pressurized vessel 1, where the fluid may be stored until use. During storage, to prevent the dry and liquid drilling fluid components from settling out of suspension, the vessels may be equipped with agitation devices, such as paddle stirrers, or alternatively, the drilling fluid may be transferred between multiple vessels in a closed loop, such as a circulation loop. In certain embodiments, a static or dynamic mixer may be included in the circulation loop, thereby continuously mixing the drilling fluid, preventing the suspension from breaking. The drilling fluid may then be transferred to a drilling site, where the fluid may be transferred from multiple process supply vessel 100 to a rig. Alternatively, the drilling fluids may be transferred from multiple process supply vessel 100 to a supply vessel or to an onshore facility. The transference of the drilling fluid may occur between multiple pressurized vessels 1, from a pressurized vessel 1 to a storage vessel, or between various storage vessels. In certain embodiments, the drilling fluids may be transferred according to the methods described in U.S. patent application Ser. No. 12/020,143, assigned to the assignee of the present application, and hereby incorporated by reference in its entirety.

Another example of a drilling fluid module may include a module for rebuilding drilling fluids. In such a module, a previously used drilling fluid may have been previously transferred to the multiple process supply vessel 100 for processing. In such a process, contaminants may have been removed from the used drilling fluid, such that the drilling fluid is ready to be remixed. Similar to the process above, during the remixing of drilling fluids, the drilling fluid may serve as the base for the rebuilding of the drilling fluid, such that additional drilling fluid components, such as chemicals, weighting agents, and the like may be added directed to the fluid base. The process of adding the drilling fluid components may occur through the transference of the components to surge tank 2, hopper 3, and mixer 4, or alternatively, depending on the properties of the components and the level of mixing required, the fluid components may be added directly to a storage tank and mixed in a closed loop cycle, as described above.

An example of a drilling waste module may include a module capable of processing drilling waste. In such a module drilling waste may be transferred from a drilling rig, supply boat, or other source to multiple process supply vessel 100. The drilling waste may be stored on multiple process supply vessel 100 in a storage vessel, or pressurized vessels 1. When an operator determines that the drilling waste is to be processed, the drilling waste may be transferred to a first separator 15, such as a centrifuge, wherein a solids portion and an effluent are produced. The solids portion may be transferred to a storage vessel or pressurized vessel 1 for storage until the solids portion is either processed further or otherwise disposed. The effluent may be transferred to effluent tank 17, or, depending on the type of fluid recovered, may be transferred to a storage vessel 5-12 or pressurized vessel 1. In certain embodiments, the effluent may then be transferred either directly from first separator 15 or a storage vessel to second separator 16, such as a dryer. In the dryer, the effluent is further processed to remove additional solid matter, and additional effluent. In the dryer, the effluent is evaporated and later condensed, so as to separate the effluent into its component parts. For example, in certain embodiments, the evaporated effluent may be condensed to separate water from hydrocarbons. Thus, the hydrocarbons and water may be collected and stored for either reuse or disposal. The separated solids portion may be transferred to a storage vessel or pressurized vessel 1 for reuse or disposal, as described above with respect to first separator 15.

Those of ordinary skill in the art will appreciate that additional separation components may be used, for example thermal treatments, which will be explained in detail below. Additionally, depending on they type of waste being processed, additional separation steps, such as hydrocyclones, vibratory separator, or the like may be used, or, alternatively, only one separator may be used. In certain embodiments, the type of separator used may depend on the type of waste being processed, the time allocated for the processing, etc.

Additional waste drilling modules may include slurrification units capable of slurrifiying drilling waste into a slurry that may be used in waste or cuttings reinjection operations. Examples of such slurrification modules are discussed in U.S. Provisional Patent Application Ser. No. 60/938,231, assigned to the assignee of the present application, and hereby incorporated by reference. Such units may receive previously separated drilling waste, such as solids and water, and reconstitute the products into a slurry for reinjection. The slurry may then be transferred to a drilling rig for reinjection, transported to another drilling rig, transported to an onshore facility, or directly reinjected from multiple process supply vessel 100.

In certain embodiments, multiple process supply vessel 100 may include an automatic tank cleaning unit 14 configured to clean storage tanks and pressurized vessels 1. While the automatic tank cleaning unit 14 will be discussed in detail below, generally, the unit 14 may clean slop, residue, and residual waste from storage tanks and pressurized vessels 1, thereby allowing the vessels to be used in additional operations. As such, a single component may be used in various functions and/or modules.

Multiple process supply vessel 100 may also include an environmental unit 13 configured to treat slop water from drilling operations. Examples of slop that may be used includes water contaminated oil based muds, oil contaminated water, sediment from tank cleaning operations, and the like. Environmental units may also be used to treat waste from other aspects of drilling and production operations.

In certain embodiments of the present application, multiple process supply vessel 100 may be primarily located in a region occupied by a number of drilling and/or production rigs. While supplying such rigs, multiple process supply vessel 100 may perform certain functions at a first rig, while providing different functions at other rigs. For example, multiple process supply vessel 100 may collect drilling waste from a first rig, and while moving to a second rig, process the drilling waste from the first rig. Multiple process supply vessel 100 may then reconstitute drilling fluids, using products of the remediated waste from the first rig, and transfer the drilling fluids to the second rig. In other embodiments, drilling fluids may be built or reconditioned on multiple process supply vessel 100, while multiple process supply vessel 100 is proximate the rig requiring such fluids. In still other embodiments, fluids may be built or waste may be remediated while multiple process supply vessel 100 is in-transit. An example of an in-transit process is described in U.S. application Ser. No. 12/020,439, assigned to the assignee of the present application, and hereby incorporated by reference.

In specific embodiments, both drilling waste remediation and drilling fluid building may occur in parallel. Thus, multiple modules may be in operation at the same time, while in other embodiments, based on the components being used for a particular operation, only a single module may be in operation at a given time.

Multiple process supply vessel 100 may also be used in other types of processing and delivery operations. For example, in certain aspects, multiple process supply vessel 100 may supply proppant to a drilling operation. Examples of proppant transference in accordance with embodiments of the present application are described in detail in U.S. Provisional Application Ser. No. 61/094,825, assigned to the assignee of the present application, and hereby incorporated by reference. In still other embodiments, multiple process supply vessel 100 may include components to mix polymers for use in drilling, completion, and production operations. Additionally, multiple process supply vessel 100 may also include cranes, helicopter landing pads, remotely operated vehicles, etc. for performing additional operations at offshore rigs.

To further explain the various components that may be combined into modules on multiple process supply vessel 100, specific components will be discussed individually. Those of ordinary skill in the art will appreciate that in order to form the various modules discussed above, the individual components may be connected and interconnected through a series of valves and conduits, thereby fluidly connecting the various components.

Pressurized Vessels

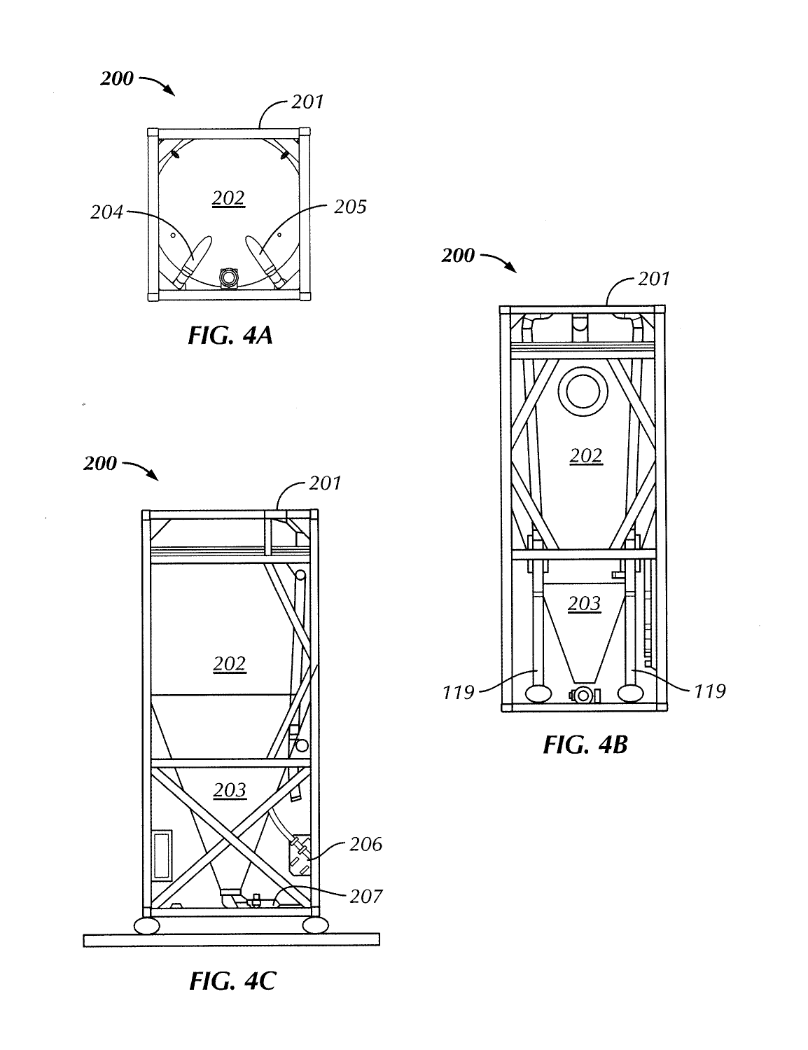

Referring to FIGS. 4A through 4C, a pressurized vessel, also referred to as a pressurized container, pressurized cuttings storage vessel, or in certain embodiments a cuttings storage vessel, according to embodiments of the present disclosure, is shown. Those of ordinary skill in the art will appreciate that as referred to herein, a pressurized container, pressurized cuttings storage vessel, and a cuttings storage vessel may be used interchangeably and according to the description in this section. FIG. 4A is a top view of a pressurized container, while FIGS. 4B and 4C are side views. One type of pressurized vessel that may be used according to aspects disclosed herein includes an ISO-PUMPT™, commercially available from M-I LLC, Houston, Tex. In such an embodiment, a pressurized container 200 may be enclosed within a support structure 201. Support structure 201 may hold pressurized container 200 to protect and/or allow the transfer of the container from, for example, a supply boat to a production platform. Generally, pressurized container 200 includes a vessel 202 having a lower angled section 203 to facilitate the flow of materials between pressurized container 200 and other processing and/or transfer equipment (not shown). A further description of pressurized containers 200 that may be used with embodiments of the present disclosure is discussed in U.S. Pat. No. 7,033,124, assigned to the assignee of the present application, and hereby incorporated by reference herein. Those of ordinary skill in the art will appreciate that alternate geometries of pressurized containers 200, including those with lower sections that are not conical, may be used in certain embodiments of the present disclosure.

Pressurized container 200 also includes a material inlet 204 for receiving material, as well as an air inlet and outlet 205 for injecting air into the vessel 202 and evacuating air to atmosphere during transference. Certain containers may have a secondary air inlet 206, allowing for the injection of small bursts of air into vessel 202 to break apart dry materials therein that may become compacted due to settling. In addition to inlets 204, 205, and 206, pressurized container 200 includes an outlet 207 through which dry materials may exit vessel 202. The outlet 207 may be connected to flexible hosing, thereby allowing pressurized container 200 to transfer materials between pressurized containers 200 or containers at atmosphere.

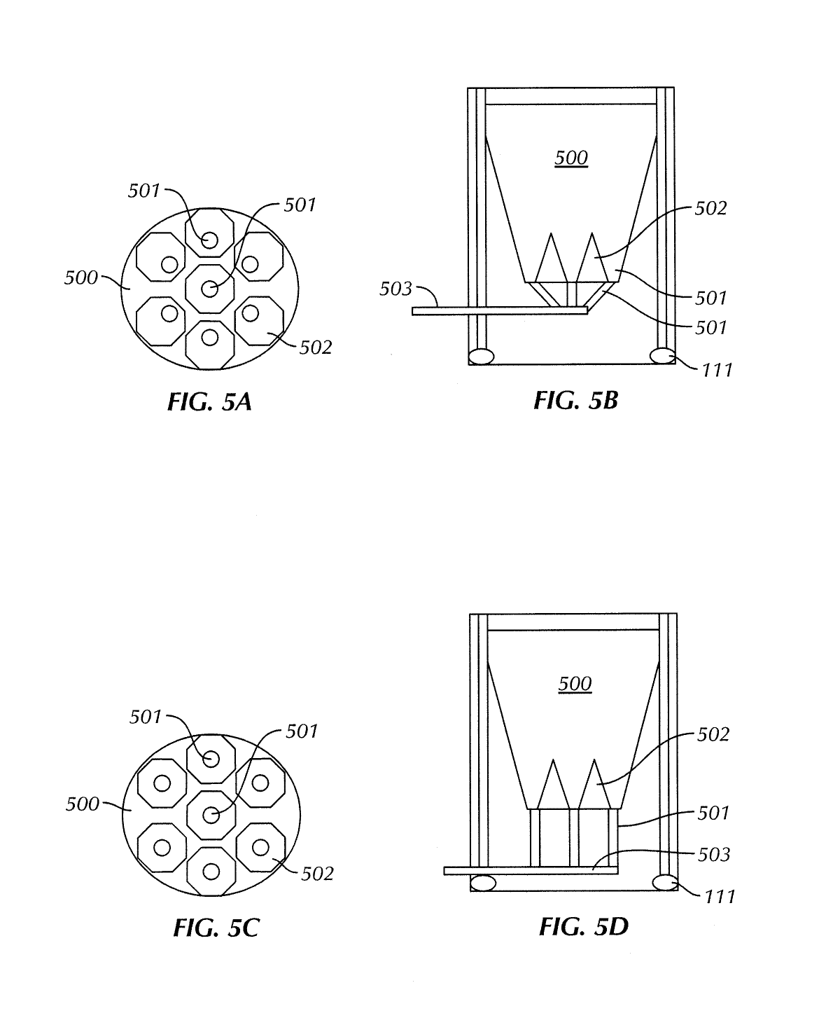

Referring to FIGS. 5A through 5D, a pressurized container 500 according to embodiments of the present disclosure is shown. FIGS. 5A and 5B show top views of the pressurized container 500, while FIGS. 5C and 5D show side views of the pressurized container 500.

Referring now specifically to FIG. 5A, a top schematic view of a pressurized container 500 according to an aspect of the present disclosure is shown. In this embodiment, pressurized container 500 has a circular external geometry and a plurality of outlets 501 for discharging material therethrough. Additionally, pressurized container 500 has a plurality of internal baffles 502 for directing a flow of to a specific outlet 501. For example, as materials are transferred into pressurized container 500, the materials may be divided into a plurality of discrete streams, such that a certain volume of material is discharged through each of the plurality of outlets 501. Thus, pressurized container 500 having a plurality of baffles 502, each corresponding to one of outlets 501, may increase the efficiency of discharging materials from pressurized container 500.

During operation, materials transferred into pressurized container 500 may exhibit plastic behavior and begin to coalesce. In traditional transfer vessels having a single outlet, the coalesced materials could block the outlet, thereby preventing the flow of materials therethrough. However, the present embodiment is configured such that even if a single outlet 501 becomes blocked by coalesced material, the flow of material out of pressurized container 500 will not be completely inhibited. Moreover, baffles 502 are configured to help prevent materials from coalescing. As the materials flow down through pressurized container 500, the material will contact baffles 502, and divide into discrete streams. Thus, the baffles that divide materials into multiple discrete steams may further prevent the material from coalescing and blocking one or more of outlets 501.

Referring to FIG. 5B, a cross-sectional view of pressurized container 500 from FIG. 5A according to one aspect of the present disclosure is shown. In this aspect, pressurized container 500 is illustrated including a plurality of outlets 501 and a plurality of internal baffles 502 for directing a flow of material through pressurized container 500. In this aspect, each of the outlets 501 are configured to flow into a discharge line 503. Thus, as materials flow through pressurized container 500, they may contact one or more of baffles 502, divide into discrete streams, and then exit through a specific outlet 501 corresponding to one or more of baffles 502. Such an embodiment may allow for a more efficient transfer of material through pressurized container 500.

Referring now to FIG. 5C, a top schematic view of a pressurized container 500 according to one embodiment of the present disclosure is shown. In this embodiment, pressurized container 500 has a circular external geometry and a plurality of outlets 501 for discharging materials therethrough. Additionally, pressurized container 500 has a plurality of internal baffles 522 for directing a flow of material to a specific one of outlets 501. For example, as materials are transferred into pressurized container 500, the material may be divided into a plurality of discrete streams, such that a certain volume of material is discharged through each of the plurality of outlets 501. Pressurized container 500 having a plurality of baffles 502, each corresponding to one of outlets 501, may be useful in discharging materials from pressurized container 500.

Referring to FIG. 5D, a cross-sectional view of pressurized container 500 from FIG. 5C according to one aspect of the present disclosure is shown. In this aspect, pressurized container 500 is illustrated including a plurality of outlets 501 and a plurality of internal baffles 502 for directing a flow of materials through pressurized container 500. In this embodiment, each of the outlets 501 is configured to flow discretely into a discharge line 503. Thus, as materials flow through pressurized container 500, they may contact one or more of baffles 502, divide into discrete streams, and then exit through a specific outlet 501 corresponding to one or more of baffles 502. Such an embodiment may allow for a more efficient transfer of materials through pressurized container 500.

Because outlets 501 do not combine prior to joining with discharge line 503, the blocking of one or more of outlets 501 due to coalesced material may be further reduced. Those of ordinary skill in the art will appreciate that the specific configuration of baffles 502 and outlets 501 may vary without departing from the scope of the present disclosure. For example, in one embodiment, a pressurized container 500 having two outlets 501 and a single baffle 502 may be used, whereas in other embodiments a pressurized container 500 having three or more outlets 501 and baffles 502 may be used. Additionally, the number of baffles 502 and/or discrete stream created within pressurized container 500 may be different from the number of outlets 501. For example, in one aspect, pressurized container 500 may include three baffles 502 corresponding to two outlets 501. In other embodiments, the number of outlets 501 may be greater than the number of baffles 502.

Moreover, those of ordinary skill in the art will appreciate that the geometry of baffles 502 may vary according to the design requirements of a given pressurized container 500. In one aspect, baffles 502 may be configured in a triangular geometry, while in other embodiments, baffles 502 may be substantially cylindrical, conical, frustoconical, pyramidal, polygonal, or of irregular geometry. Furthermore, the arrangement of baffles 502 in pressurized container 500 may also vary. For example, baffles 502 may be arranged concentrically around a center point of the pressurized container 500, or may be arbitrarily disposed within pressurized container 500. Moreover, in certain embodiments, the disposition of baffles 502 may be in a honeycomb arrangement, to further enhance the flow of materials therethrough.

Those of ordinary skill in the art will appreciate that the precise configuration of baffles 502 within pressurized container 500 may vary according to the requirements of a transfer operation. As the geometry of baffles 502 is varied, the geometry of outlets 501 corresponding to baffles 502 may also be varied. For example, as illustrated in FIGS. 5A-5D, outlets 501 have a generally conical geometry. In other embodiments, outlets 501 may have frustoconical, polygonal, cylindrical, or other geometry that allows outlet 501 to correspond to a flow of material in pressurized container 502.

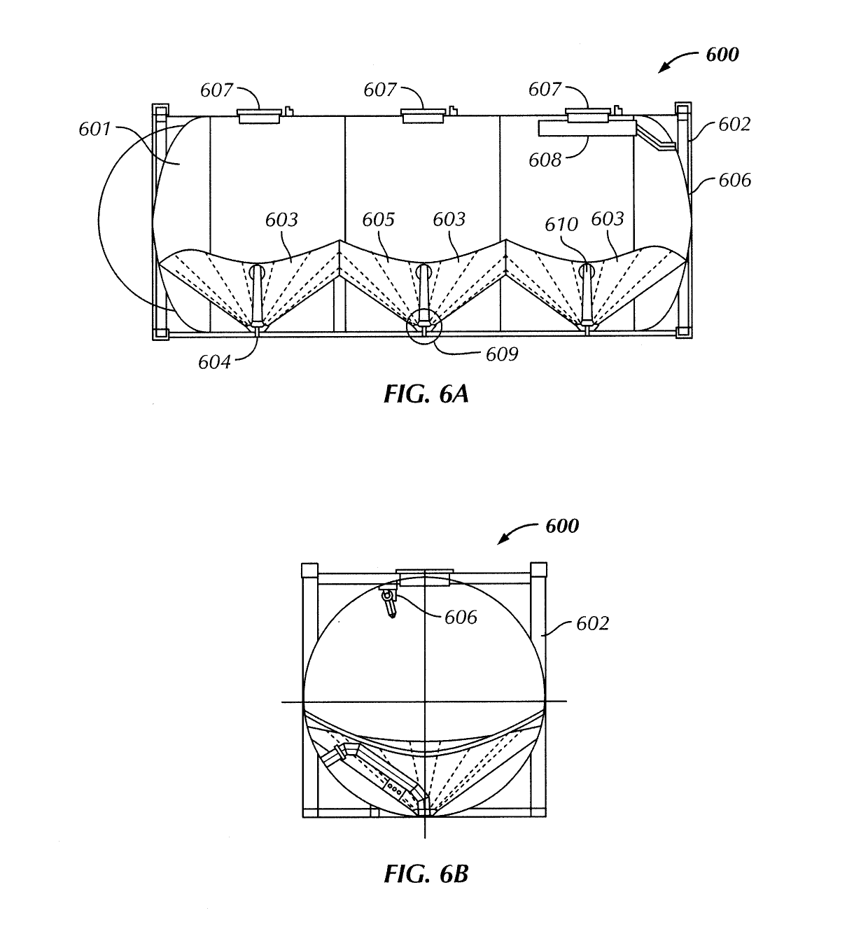

Referring now to FIGS. 6A through 6B, alternate pressurized containers according to aspects of the present disclosure are shown. Specifically, FIG. 6A illustrates a side view of a pressurized container, while FIG. 6B shows an end view of a pressurized container.

In this aspect, pressurized container 600 includes a vessel 601 disposed within a support structure 602. The vessel 601 includes a plurality of conical sections 603, which end in a flat apex 604, thereby forming a plurality of exit hopper portions 605. Pressurized container 600 also includes an air inlet 606 configured to receive a flow of air and material inlets 607 configured to receive a flow of materials. During the transference of materials to and/or from pressurized container 600, air is injected into air inlet 606, and passes through a filtering element 608. Filtering element 608 allows for air to be cleaned, thereby removing dust particles and impurities from the airflow prior to contact with the material within the vessel 601. A valve 609 at apex 604 may then be opened, thereby allowing for a flow of materials from vessel 601 through outlet 610. Examples of horizontally disposed pressurized containers 600 are described in detail in U.S. Patent Publication No. 2007/0187432 to Brian Snowdon, and is hereby incorporated by reference.

Automatic Tank Cleaning Unit

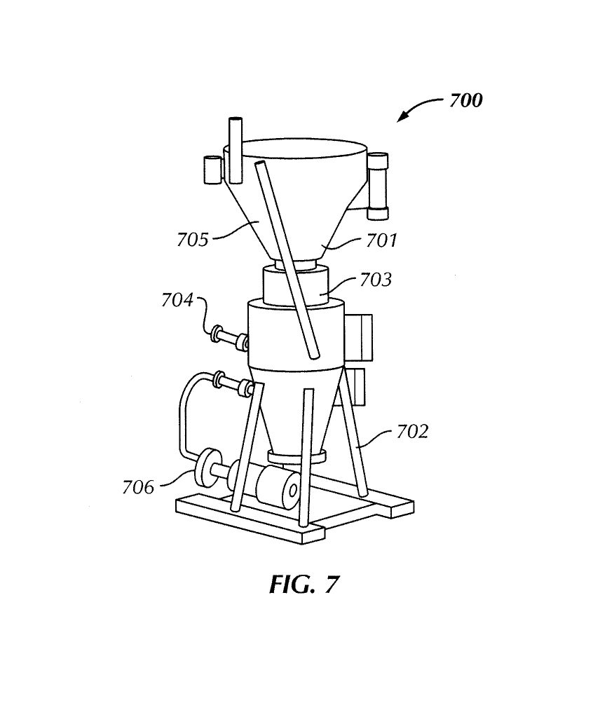

Referring now to FIG. 7, a pressurized transference device, according to embodiments of the present disclosure, is shown. Pressurized transference device 700 may include a feed chute 701 through which materials may be gravity fed. After the materials have been loaded into the body 702 of the device, an inlet valve 703 is closed, thereby creating a pressure-tight seal around the inlet. Once sealed, the body is pressurized, and compressed air may be injected through air inlet 704, such that the dry material in body 702 is discharged from the pressurized transference device in a batch. In certain aspects, pressurized transference device 700 may also include secondary air inlet 705 and/or vibration devices (not shown) disposed in communication with feed chute 701 to facilitate the transfer of material through the feed chute 701 by breaking up coalesced materials.

During operation, the pressurized transference device 700 may be fluidly connected to pressurized containers, such as those described above, thereby allowing materials to be transferred therebetween. Because the materials are transferred in batch mode, the materials travel in slugs, or batches of material, through a hose connected to an outlet 706 of the pressurized transference device. Such a method of transference is a form of dense phase transfer, whereby materials travel in slugs, rather than flow freely through hoses, as occurs with traditional, lean phase material transfer.

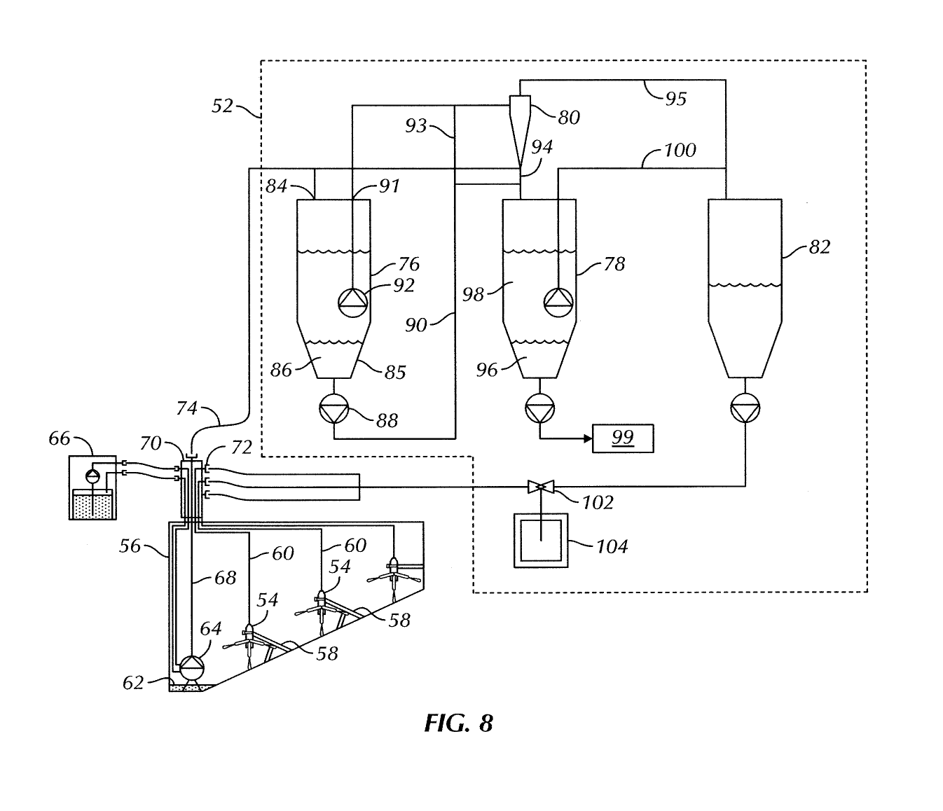

Referring now to FIG. 8, a tank cleaning system incorporating at least one drill cuttings vessel is illustrated. The tank cleaning system may include a water recycling unit 52 and one or more manual or automated tank cleaning machines, such as rotary jet head washers 54. Rotary jet head washers 54 may be positioned within a mud tank 56, or any other tank being cleaned. Although shown as being fixed in position, these multi-headed or single-headed nozzle rotary jet head washers 54 may be lowered into the tank 56 or otherwise suspended and positioned temporarily or permanently within the tank 56 using brackets 58, stands, penetration through the deck/side of the tank, or the like. The rotary jet head washers 54 may be supplied with pressurized wash fluid by way of the wash fluid lines 60. The rotation of the nozzles might be provided by a pneumatic motor or by a turbine in the cleaning fluid flow. As the wash fluid exits the rotary jet head washers 54, tank 56 is washed with pressurized wash fluid that dislodges any solids or sediment present in tank 56, generating tank slop 62, a combination of solids and wash fluid.

A hydraulic pump 64 may be connected to a hydraulic power unit 66, so that hydraulic pump 64 may siphon the tank slop 62 and pump the combination of solids and wash fluid up the tank slop line 68. As shown, the hydraulic pump 64 is lowered into the tank 56 for use in the washing operation; alternatively, the pump 56 may be mounted either temporarily on brackets or permanently mounted in the tank 56. The tank slop line 68 may carry the tank slop 62 directly to the water recycling unit 52 or through a modular fluid distribution manifold 70 designed with control valves (not shown) and hose connections 72, or quick connect hose lines in some embodiments. Tank slop 62 may then be transmitted by way of external slop line 74 to the water recycling unit 52.

Water recycling unit 52 may include a water recovery tank 76, a cuttings box 78, and a filtration system 80. Water recycling unit 52 may also include a clean water tank 82. In some embodiments, one or more of the water recovery tank and the cuttings box may be as described in U.S. Patent Application Publication No. 20050205477. In some embodiments, one or more cuttings storage vessels, as disclosed above, may be integrated into the tank cleaning system and may function as one or more of the water recovery tank 76, the cuttings box 78, and the clean water tank 82.

The tank slop 62 may be pumped into a top portion of the water recovery tank 76 at an inlet 84. The water recovery tank 76 may have a sloped bottom 85 that may be round, square, or rectangular. Solids 86 from the tank slop 62 may settle to the bottom of the water recovery tank 76 and may gather in the sloped bottom 85. The solids 86 that collect at the sloped bottom 85 of the water recovery tank 76 may then be pumped by an auger fed progressive cavity pump 88 to the cuttings box 78 through a line 90. Alternatively, solids 86 may be released from the water recovery tank 76 by a valve and pumped to the cuttings box 78.

The liquid in the water recovery tank 76 may be pumped to one or more filtration systems 80, which may include one or more hydrocyclones, centrifuges, filters, filter presses, and hydrocarbon filters. In some embodiments, the liquid may be transmitted through an outlet 91, such as by a diving pump or submersible pump 92. In other embodiments, a solids-rich fraction and a solids-lean fraction may be sequentially pumped from water recovery tank 76 via pump 88, where the solids-rich fraction may be directed to cuttings box 78, and the dirty water or solids-lean fraction may be transmitted to filtration system 80 through line 93. Other alternative flow schemes may also be used, such as where the settling efficiency is sufficient to develop a clean water fraction in water recovery unit 76.

In a hydrocyclone 80, for example, small solids that did not settle out of the fluid when introduced in the water recovery tank 76 may be removed by the centrifugal force created within the hydrocyclone 80. Solids may be directed by purge flow line 94 from the hydrocyclone 80 to the cuttings box 78. Additionally, the solids may be gravity fed or pumped from the hydrocyclone 80 to the cuttings box 78 or to a disposal vessel. The overflow from the hydrocyclone 80 may be directed through line 95 to the clean water tank in some embodiments, or recycled to directly supply water to the rotary jet head washers 54 in other embodiments.

The cuttings box 78 may be used to further promote the settling of the solids 86 from the slurry. Cuttings box 78 may be any cuttings box normally found onboard drilling rigs, for example, or may be a cuttings storage vessel. Cuttings box 78 may separate the solids 86 into a solids fraction 96 and a solids-lean fraction 98. In some embodiments, an oil fraction (not shown) may also form in cuttings box 78. The solids fraction 96 may be pumped to a disposal vessel 99, for example, a cuttings storage vessel, for later disposal. The solids-lean fraction 98 may be pumped via fluid line 100 to the clean water tank 82 or recycled to directly supply water to the rotary jet head washers 54.

As previously discussed, the cuttings box 78 may be any cuttings box as used onboard a rig and as typically used to transport drill cuttings. Once a first cuttings box 78 is nearly full with solids 96, a second cuttings box (not individually illustrated) may then replaces the first cuttings box 78. Valves (not shown) may be used to temporarily stop or divert the flow to the cuttings box 78 while it is replaced with a second cuttings box.

Alternatively, a cuttings storage vessel may be integrated into a tank cleaning system and may function as a cuttings box. When a cuttings storage vessel 22 operating as a cuttings box is nearly full with solids and liquids, additional cutting storage vessels, if available, may be used as a cuttings box, separating solids and liquids.

In some embodiments, the clean water recovered from the water recovery tank 76 and the cuttings box 78 may be pumped through flow lines 60 to one or more rotary jet head washers 54 to clean the tank 56. In other embodiments, the clean water recovered from the water recovery tank 76 may be returned to an existing clean water storage vessel (not shown) on the rig. In yet other embodiments, the clean water recovered from the water recovery tank 76 may be stored in a cuttings storage vessel operating as a storage tank for use in the tank cleaning system 52.

To assist the cleaning of tanks 56 using the above described tank cleaning system, it may be desired to use various chemicals, such as cleaning chemicals, in addition to the water provided to rotary jet head washers 54. A wide variety of wash fluids may be used, including detergents, surfactants, antifoaming agents, suspending agents, lubricating agents (to reduce the wear caused by the flowing solids), and the like, to assist in the quick and efficient cleaning of the tank 56. A chemical inductor 102 may be used to add such cleaning chemicals 104 to the wash water.

As described above, a cuttings storage vessel may be integrated into the cleaning system and may function as one or more of the water recovery tank, the cuttings box, and the clean water tank. In some embodiments, where a cuttings storage vessel functions as a water recovery tank or a cuttings box, more than one outlet may be provided for pumping the solids and liquid fractions. In other embodiments, the solids fraction and liquid fractions may be sequentially transmitted from the cuttings tank to their respective destinations. Sequential transmission may be facilitated by providing a sight glass for an operator to visually determine when the flow has changed from the solids fraction to a solids-lean fraction. Alternatively, measurement of conductance or density may be used to indicate when the flow has changed from the solids fraction to a solids-lean fraction. Upon determination of the flow transition, an operator or automated system may appropriately redirect the flow.

In some embodiments, a settling efficiency of solids within a cuttings storage vessel may eliminate the need for various components of the cleaning system. For example, a cuttings storage vessel may have a larger volume, diameter, or height than current water recovery tanks and cuttings boxes used in tank cleaning systems, such that the flow of tank slop into the cuttings storage vessel may not disturb the settling of solids.

Alternatively, use of a cuttings storage vessel or more than one cuttings storage vessel as a water recovery tank may allow complete or nearly complete settling of solids in one cuttings storage vessel prior to pumping the solids fraction and the solids-lean fraction from the cuttings storage vessel. Where complete or nearly complete settling of solids in a cuttings storage vessel may be achieved, it may be possible, in some embodiments, to eliminate the cuttings box from the tank cleaning system.

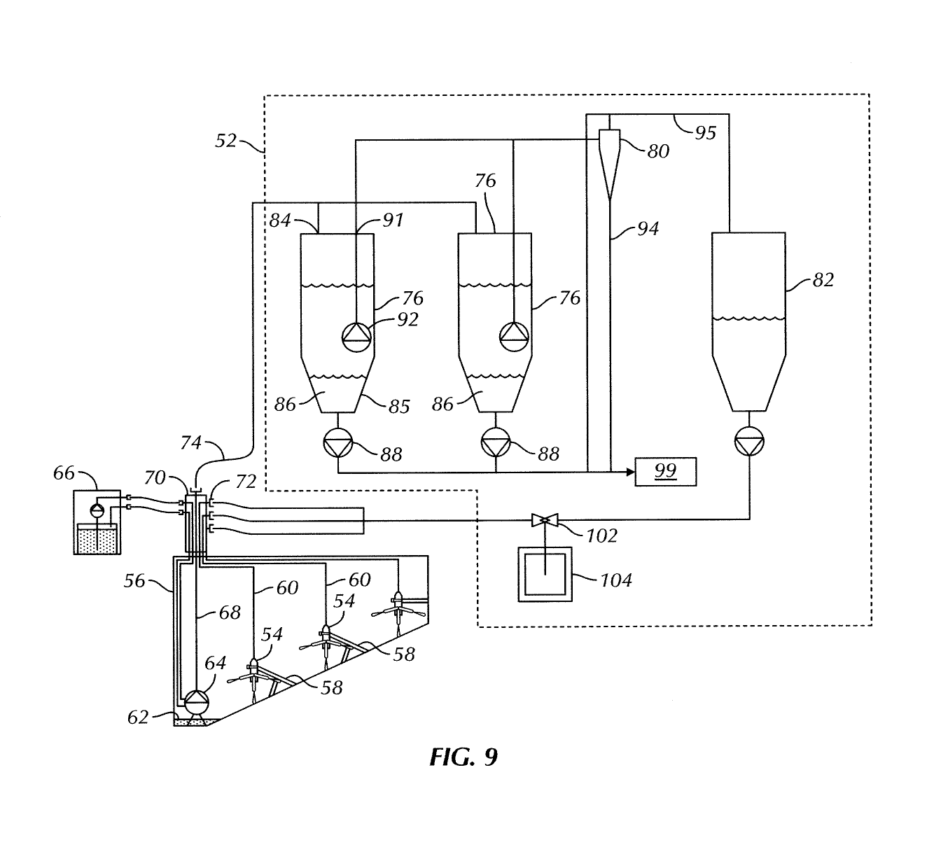

Referring now to FIG. 9, another embodiment of a tank cleaning system 52 integrating at least one cuttings storage vessel is illustrated, where like numerals represent like components. In this embodiment, adequate liquid-solids separations may be attained in cuttings storage vessel(s) to allow the cuttings box to be excluded from the system. Solids fraction 86 pumped from one or more cuttings storage vessels 76 functioning as a water recovery tank may be mixed in a mixer M and may accumulate in a separate disposal vessel 99 for later disposal. Dirty water may be processed in hydrocyclone 80, separating solids 94 and clean water 95. As above, the solids and solids-lean fractions may be pumped through separate outlets from water recovery tanks 76, or may be sequentially pumped from the sloped bottom 85 of the water recovery tanks 76, where the solids-lean fraction may be transmitted via line 93 to hydrocyclone 80.

In some embodiments, the use of hydrocyclones 80 to remove fine solids from the water may not be necessary for the operation of the tank cleaning system 52 due to the settling that may be attained within a cuttings storage vessel. Efficiency of the system 52 may be reduced when no further separation operations, such as hydrocyclone 80, are included. Thus, processing of a solids-lean fraction from a cuttings storage vessel through hydrocyclones 80 may be optional in some embodiments; in other embodiments, a cleaning system may not include hydrocyclones.

As illustrated and described with respect to FIGS. 8-9, one or more cuttings storage vessels may be integrated into a tank cleaning system and may function as a water recovery tank, a cuttings box, and/or a clean water storage tank. In some embodiments, the one or more cuttings storage vessels may be integrated into a tank cleaning system using a module. A module may allow for equipment used in the tank cleaning system to be conveniently lifted to the rig when needed and from the rig when cleaning operations have concluded. Depending upon the function of a cuttings storage vessel in the tank cleaning system, the module may include one or more fluid connections that are in fluid communication with an inlet or an outlet of a cuttings storage vessel, or that are in fluid communication with other external components of a tank cleaning system, such as a tank slop pump. Components contained in the module may include the components of the tank cleaning system, as described above with respect to FIGS. 3-4, excluding the vessels that the cuttings storage vessels may be functioning as and/or replacing.

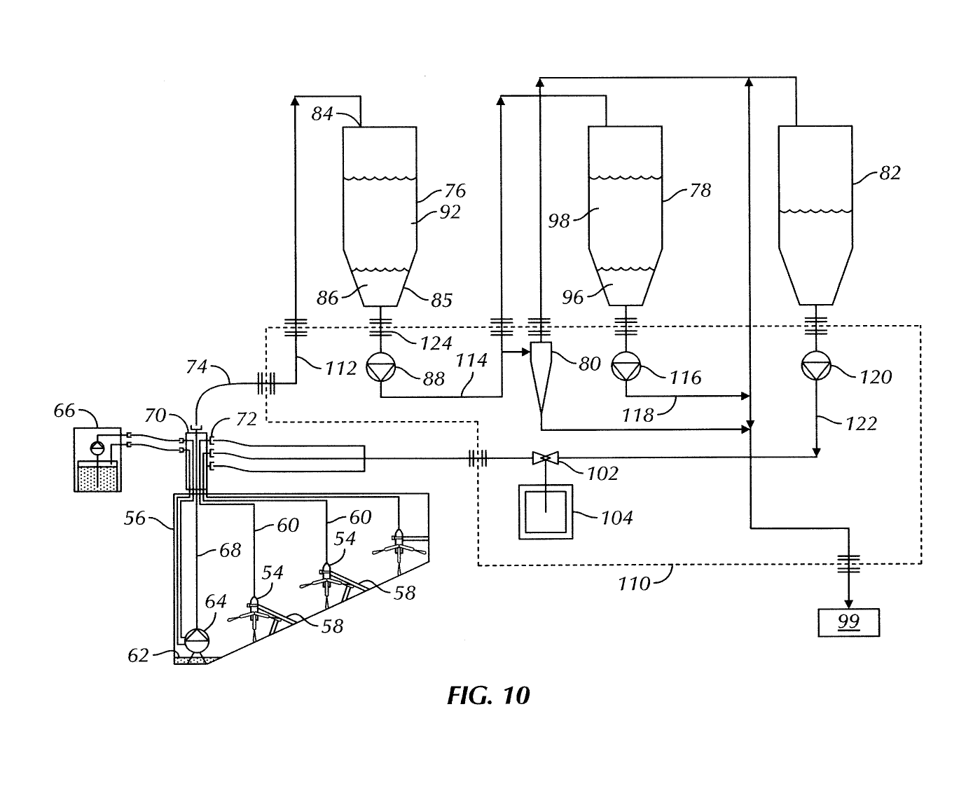

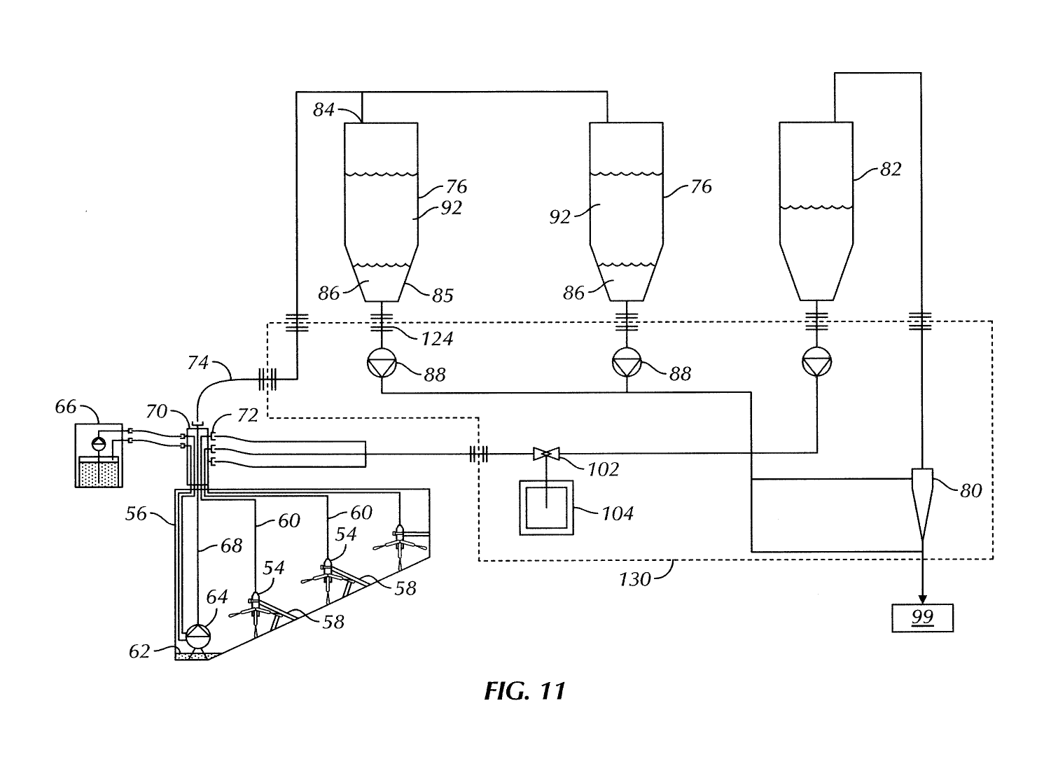

As illustrated in FIGS. 10-11, one or more cuttings storage vessels may be integrated into a tank cleaning system using a module, where like numerals represent like parts. As illustrated, the tank cleaning system flow diagrams illustrate modules where materials in the cuttings vessels are pumped sequential from the vessel. One skilled in the art would appreciate that other flow schemes, for example, having a separate pump for the solids-lean fractions, may be included with the modules. One skilled in the art would also appreciate that other equipment not shown on the simplified flow diagrams may also be used, including valves, control valves, power supplies, filters, pressure regulators, and the like.

Referring now to FIG. 10, one embodiment of a module 110 to integrate one or more cuttings storage vessels into a tank cleaning system according to embodiments disclosed herein, is illustrated. As cuttings storage vessels may function as one or more of the water recovery tank 76, the cuttings box 78, and the clean water storage tank 82, the equipment contained in a module may vary. For example, module 110 may provide a fluid communication conduit 112 for transmitting tank slop 62 from line 74 to inlet 84 of vessel 76. Additionally, module 110 may include pumps 88 and conduit 114 for transmitting solids 86 and solid-lean fluids 92 from water recovery tank 76 to filtration system 80 and cuttings box 78. Module 110 may also provide pumps 116 and conduit 118 for transmitting solids 96 and solids-lean fractions 98 from cuttings box 78 to disposal vessel 99 and clean water tank 82, respectively. Further, module 110 may include pumps 120 and conduit 122 for transmitting clean water from water tank 82 to rotary jet head cleaners 54. Where not individually provided on a rig, module 110 may also include a chemical inductor 102 and cleaning chemicals 104.

Connections 124 between conduit within module 110, the integrated cuttings storage vessels, and distribution manifold 70 may be flanged, screwed, or quick-connect connections. Additionally, module 110 may include spooled conduit for attaching to various inlets and outlets of the cuttings storage vessels, disposal vessels 99, and manifold 70. Spooled conduit may be useful for attaching to inlets and outlets remote from the location where the module is located on the rig.

Referring now to FIG. 11, another embodiment of a module to integrate cuttings storage vessels into a tank cleaning system, according to embodiments disclosed herein, is illustrated. One or more cuttings storage vessels may be integrated into a tank cleaning system using a module 130, where the cuttings storage vessels are used in parallel as water recovery tanks 76, similar to FIG. 5, without a cuttings box. Similar to module 110, module 130 may provide for pumps and fluid communication between flow manifold 70, vessels 76, 82, 99, hydrocyclone 80 (when used), and chemical inductor 102 and cleaning chemicals 104.

The modules described above with respect to FIGS. 5-6 may additionally include programmable logic controllers, digital control system connections, chemical inductor(s) and cleaning chemical tank(s), power connections, among other equipment and lines. For example, a control system may be provided to locally or remotely operate the tank cleaning system.

Other module systems for integrating cuttings storage vessels into a tank cleaning system may be envisaged. The modules described above with respect to FIGS. 5-6 may include or exclude various components due to the existing lines and equipment located on the rig, and the type and number of cuttings storage vessels integrated into a tank cleaning system. For example, FIGS. 5-6 illustrate integration of three cuttings storage vessels, whereas additional or fewer cuttings storage vessels may be integrated, requiring fewer or additional components to be included in the module.

In some embodiments, ISO-PUMPS may be used as cuttings storage vessels integrated into the tank cleaning system. ISO-PUMPS may be used to transfer cuttings and fluids between vessels without the need for a pump 88, for example. Where ISO-PUMPS may provide for transmitting fluids and solids between vessels, the equipment required for modules 110, 130 may be further minimized.

As mentioned above, where cuttings storage vessels may provide for adequate separation of the liquids and solids fractions, hydrocyclone 80 may not be a necessary component. Thus, in some embodiments, hydrocyclone 80 and related equipment and lines may not be included in module 110, 130.

Additionally, existing lines may be provided for fluid communication between the cuttings storage vessels integrated into the cuttings storage system using a module 110, 130. For example, a cuttings storage system may provide for communication between one cuttings storage vessel outlet and an inlet of a second cuttings storage vessel. Additionally, a cuttings storage system may provide for common inlet and/or common outlet lines. Module 110, 130 may advantageously connect to these common lines, simplifying and/or minimizing the lines and equipment needed to integrate the cuttings storage vessels into a tank cleaning system. Additional examples of tank cleaning units are described in U.S. Pat. No. 7,232,525, assigned to the assignee of the present application, and hereby incorporated by reference.

Slurrification Unit

Integration of a cuttings storage vessel into a slurrification system is now described with respect to cuttings storage vessel(s) disposed on a rig. One of ordinary skill in the art, however, will appreciate that the cuttings storage vessels may be disposed at any work site, including a rig, a transport vehicle, or other treatment facility, without departing from the scope of embodiments disclosed herein. In this embodiment a module may be disposed at the work site proximate the cuttings storage vessel and operatively connected to the cuttings storage vessel, thereby converting the cuttings storage vessel from a vessel for storing cuttings to a component of a slurrification system.

As described above, previous fluid slurrification systems required the conversion of valuable drilling rig space for storing independent fluid recovery vessels and processing equipment. However, embodiments disclosed herein allow existing structural elements (i.e., cuttings storage vessels 202) to be used in multiple operations. Modules in accordance with embodiments disclosed herein are relatively small compared to previous systems, thereby preserving valuable drill space, and preventing the need for costly and dangerous lifting operations.

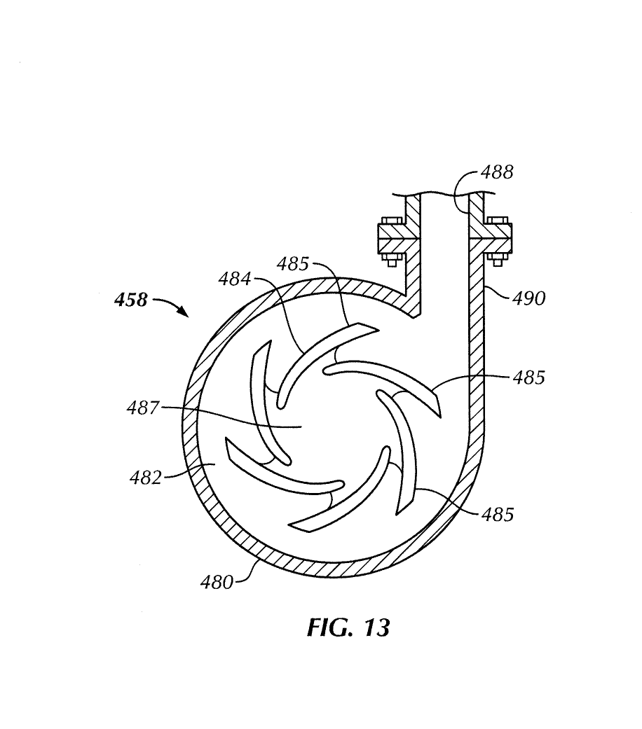

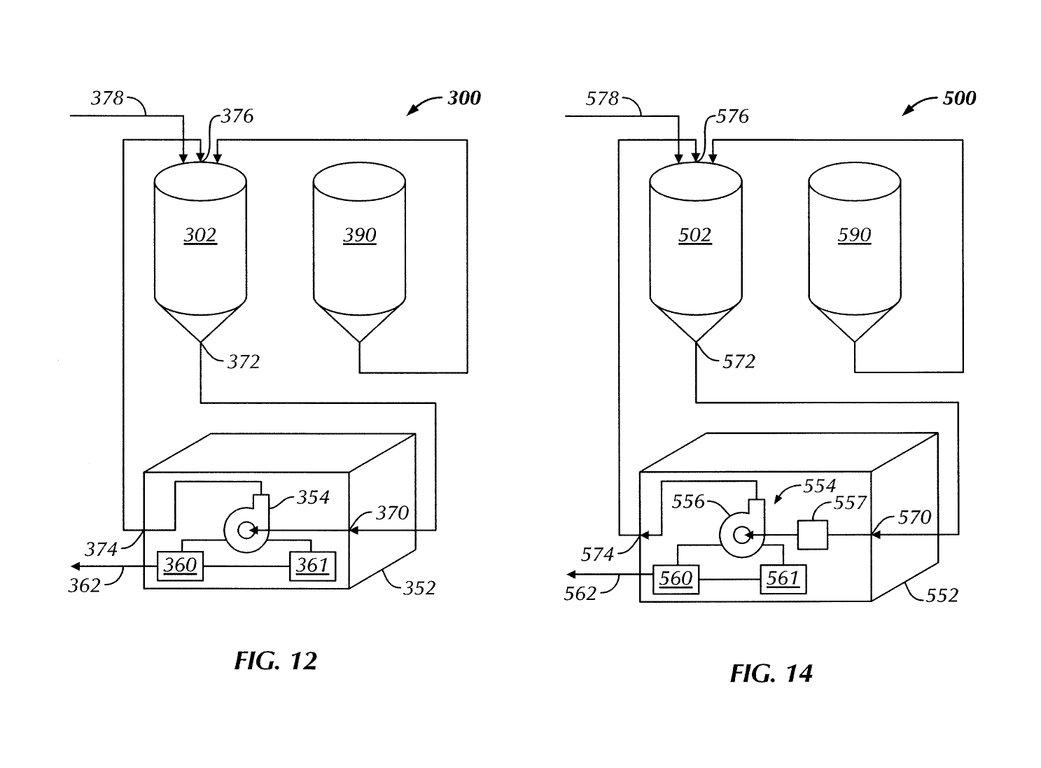

Referring now to FIG. 12, a slurrification system 300 incorporating a first cuttings storage vessel 302 is illustrated. Slurrification system 300 includes a module 352, or drive unit, configured to operatively connect with the first cuttings storage vessel 302, and a fluid supply line 378. Module 352 may include a containment unit, a skid, a housing, or a moveable platform configured to house select slurrification system components, as described in more detail below.

In this embodiment, system 300 includes an independent power source 360 for providing power to components of module 352. Power source 360 is electrically connected to, for example, grinding device 354 and/or a programmable logic controller (PLC) 361. Those of ordinary skill in the art will appreciate that such a power source may provide primary or auxiliary power for powering components of module 352. In other embodiments, power source 360 may be merely an electrical conduit for connecting a power source on a rig (not shown) via an electrical cable 362, to module 352.

Module 352 includes an inlet connection 370 configured to connect with outlet 372 of first cuttings storage vessel 302, and an outlet connection 374 configured to connect with an inlet 376 of first cuttings storage vessel 302. Inlet connection 370 may be connected to outlet 372 and outlet connection 374 may be connected to inlet 376 by fluid transfer lines, for example, flexible hoses and/or new or existing piping. Module 352 further includes a grinding device 354 configured to facilitate the transfer of fluids from the first cuttings storage vessel 302, through the module 352, and back to the first cuttings storage vessel 302. Grinding device 354 is configured to reduce the particle size of solid materials of the drill cuttings transferred therethrough.

In one embodiment, grinding device 354 may include a grinding pump. The grinding pump may be, for example, a centrifugal pump, as disclosed in U.S. Pat. No. 5,129,469, and incorporated by reference herein. As shown in FIG. 13, a centrifugal pump 458, configured to grind or reduce the particle size of drill cuttings, may have a generally cylindrical casing 480 with an interior impeller space 482 formed therein. Centrifugal pump 458 may include an impeller 484 with backward swept blades with an open face on both sides, that is, the blades or vanes 485 are swept backward with respect to a direction of rotation of the impeller and are not provided with opposed side plates forming a closed channel between the impeller fluid inlet area 487 and the blade tips. The casing 480 has a tangential discharge passage 488 formed by a casing portion 490. The concentric casing of centrifugal pump 458 and the configuration of the impeller blades 485 provide a shearing action that reduces the particle size of drill cuttings. The blades 485 of the impeller 484 may be coated with a material, for example, tungsten carbide, to reduce wear of the blades 485. One of ordinary skill in the art will appreciate that any grinding pump known in the art for reducing the size of solids in a slurry may be used without departing from the scope of embodiments disclosed herein.

In an alternative embodiment, as shown in FIG. 14, grinding device 554 may include a pump 556 and a grinder 557, for example, a ball mill. In this embodiment, cuttings may be injected into the grinder 557, wherein the particle size of the solids is reduced. The pump 556 may then pump the slurry back to first cuttings vessel 502. In one embodiment, the pump may include a grinding pump, as disclosed above, as a second grinder, for further reduction of the particle size of solids exiting the grinder 557.

Referring back to FIG. 12, in one embodiment, slurrification system 300 further includes a second cuttings storage vessel 390. Second cuttings storage vessel 390 may be configured to supply cuttings to first cuttings storage vessel 302. In one embodiment, a pump (not shown), as known in the art, may be used to transfer the cuttings. In another embodiment, a pneumatic transfer device (not shown), as disclosed above, may be used to transfer the cuttings to the first cuttings storage vessel 302. One of ordinary skill in the art will appreciate that any method for transferring the cuttings to first storage vessel 302 may be used without departing from the scope of embodiments disclosed herein.

In one embodiment, module 352 may further include a pneumatic control device (not shown) to control the flowrate of air injected into the cuttings storage vessel 302 by a pneumatic transfer device (not shown). In such an embodiment, an air line (not shown) from an air compressor (not shown) may be coupled to the pneumatic control device (not shown) in module 352 to control a flow of air into first cuttings storage vessel 302.

In another embodiment, cuttings may be supplied to first cuttings storage vessel 302 from a classifying shaker (not shown) or other cuttings separation or cleaning systems disposed on the drilling rig. Additionally, multiple cuttings storage vessels may be connected to and supply cuttings to first cuttings storage vessel 302. In one embodiment, each cuttings storage vessel may be configured to supply cuttings of predetermined sizes, for example, coarse cuttings or fines. Cuttings of a selected size may then be provided to first cuttings storage vessel 302 to form a slurry of a predetermined density. One of ordinary skill in the art will appreciate that the cuttings may be transferred to the first cuttings storage vessel 302 by any means known in the art, for example, by a pump or a pneumatic transfer device, as described above.

During operation of slurrification system 300, fluid supply line 378 may be configured to supply a fluid to first cuttings storage vessel 302. One of ordinary skill in the art will appreciate that the fluid supply line 378 may supply water, sea water, a brine solution, chemical additives, or other fluids known in the art for preparing a slurry of drill cuttings. As the fluid is pumped into first cuttings storage vessel 302, cuttings from the second cuttings storage vessel 390, or other components of the rig's cuttings separation system, as described above, may be transferred into first cuttings storage vessel 302.

As first cuttings storage vessel 302 fills with fluid and cuttings, the mixture of fluid and cuttings is transferred to module 352 through the inlet connection 370 of the module 352. In one embodiment, the mixture may be transferred by a pneumatic transfer device, a vacuum system, a pump, or any other means known in the art. In one embodiment, the pneumatic transfer device may include a forced flow pneumatic transfer system. The mixture of fluid and cuttings is pumped through grinding device 354, wherein the cuttings are reduced in size. The mixture, or slurry, is then pumped back to first cuttings storage vessel 302 via outlet connection 374. The slurry may cycle back through module 352 one or more times as needed to produce a slurry of a predetermined density or concentration of cuttings as required for the particular application or re-injection formation.

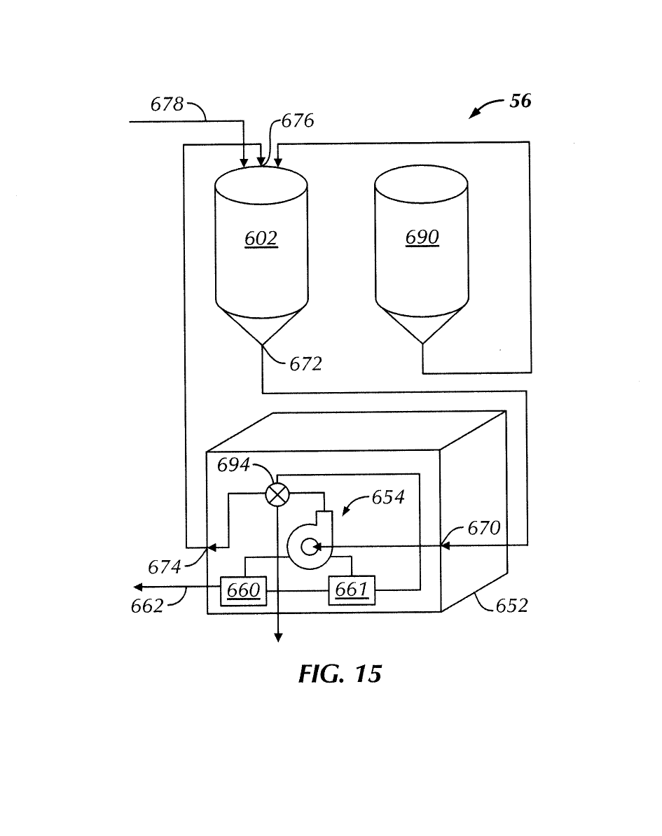

Referring now to FIG. 15, in one embodiment, module 652 further includes a valve 694 disposed downstream of grinding device 654, wherein valve 694 is configured to redirect the flow of the slurry exiting the grinding device 654. In one embodiment, a PLC 661 may be operatively coupled to module 652 and configured to close or open the valve 694, thereby redirecting the flow of the slurry. In one embodiment, the PLC 695 may control the valve 694 to move after a pre-determined amount of time of fluid transfer through module 652. In another embodiment, a sensor (not shown) may be operatively coupled to the valve 694 to open or close the valve when a pre-determined condition of the slurry is met. For example, in one embodiment, a density sensor (not shown) may be coupled to valve 694, such that, when the density of the slurry exiting grinding device 654 reaches a pre-determined value, valve 694 moves, i.e., opens or closes, and redirects the flow of the slurry from the first cuttings storage vessel 302 to another cuttings storage vessel, a slurry tank, a skip, or injection pump for injection into a formation.

In another embodiment, a conductivity sensor (not shown) may be coupled to valve 694, such that, when the density of the slurry exiting grinding device 654 reaches a pre-determined value, valve 694 moves and redirects the flow of the slurry from the first cuttings storage vessel 302 to another cuttings storage vessel, a slurry tank, a skip, or injection pump for injection into a formation. One of ordinary skill in the art will appreciate that other apparatus and methods may be used to redirect the flow of the slurry once a predetermined concentration of cuttings in suspension, density, or conductivity has been met. Commonly, a slurry with a concentration of up to 20% cuttings in suspension is used for re-injection into a formation. However, those of ordinary skill in the art will appreciate that direct injection of slurry, using embodiments of the present disclosure, may provide for an increased concentration of cuttings in the slurry.

A slurry formed by a slurrification system, as described above, may be transferred to another cuttings storage vessel, a slurry tank, a skip, or directly injected into a formation. Slurry that is transferred to a tank, vessel, skip, or other storage device, may be transferred off-site to another work site. In one embodiment, the storage device may be lifted off of a rig by a crane and transferred to a boat. Alternatively, slurry may be transferred from the storage device to a slurry tank disposed on the boat.

In one embodiment, the slurry may be transported from one work site to another work site for re-injection. For example, the slurry may be transported from an offshore rig to another offshore rig. Additionally, the slurry may be transported from an offshore rig to an on-land work site. Further the slurry may be transported from an on-land work site to an offshore work site.

Those of ordinary skill in the art will appreciate that the components of systems 300, 500, and 600 may be interchanged, interconnected, and otherwise assembled in a slurrification system. As such, to address the specific requirements of a drilling operation, in particular, for cuttings re-injection, the components of the systems and modules disclosed herein may provide for an interchangeable and adaptable system for slurrification at a drilling location.

Environmental Unit

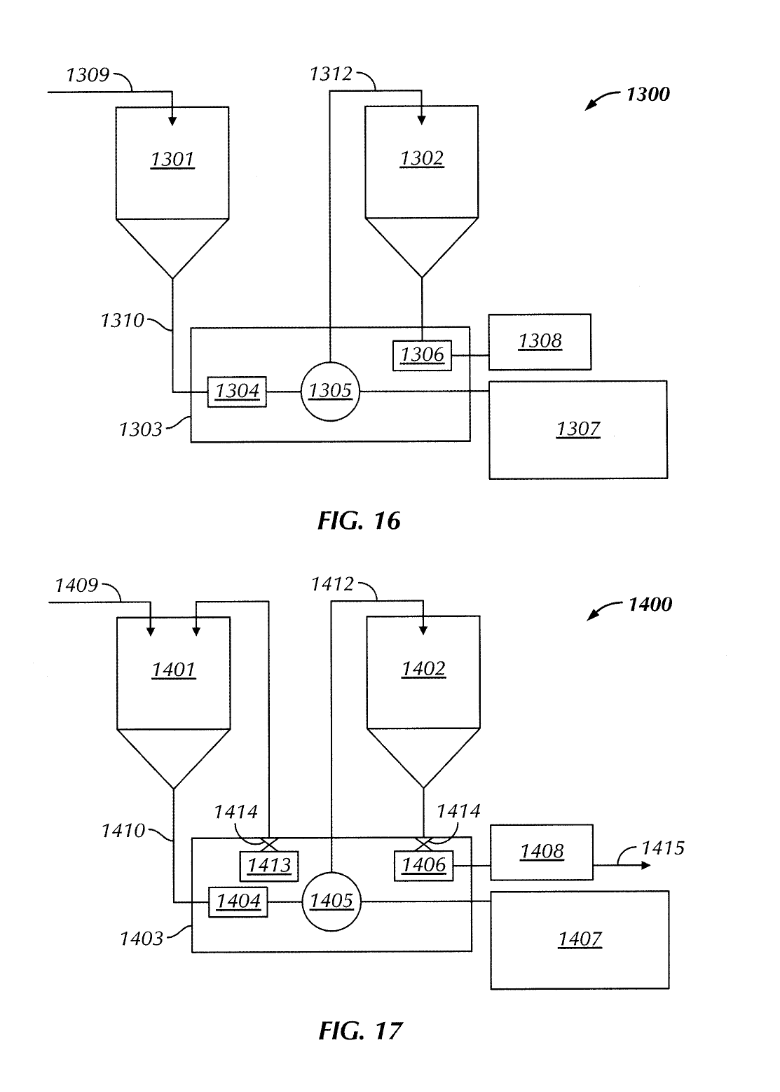

Referring to FIG. 16, a system 1300 for recycling drilling fluid according to one embodiment of the present disclosure is shown. In this embodiment, system 1300 includes a first cuttings storage vessel 1301, a second cuttings storage vessel 1302, and a module 1303. Module 1303 includes a pump 1304, a valve 1305, and a filter system 1306. Valve 1305 provides fluid communication between first cuttings storage vessel 1301 and second cuttings storage vessel 1302 and/or a drilling waste reservoir 1307. Drilling waste reservoir 1307 may be an existing structural element of a drilling rig, such as a mud pit or collection tank, or in alternate embodiments, may be a component of module 1303. Second cuttings storage vessel 1302 is fluidly connected to filter system 1306, and filter system 1306 is fluidly connected to a cleaned fluids reservoir 1308. Cleaned fluids reservoir 1308 may be an existing structural element of a drilling rig, or in alternate embodiments, may be a component of module 1303. In certain embodiments, those of ordinary skill in the art will appreciate that either drilling waste reservoir 1307 or cleaned fluids reservoir 1308 may also include cuttings storage vessels 1302.

During operation, used drilling fluid, including drill cuttings, particulate matter, suspended materials, chemicals used during the drilling operation, and other materials commonly associated with used drilling fluid is pumped into first cuttings storage vessel 1301 via supply line 1309. The used drilling fluid may be mixed with water in first cuttings storage vessel 1301, or pumped into first cuttings vessel 1301 without the addition of water and/or other additives. The mixture in first storage vessel 1301 may be agitated by mechanical means (e.g., an agitator) or otherwise agitated via the addition of liquids (e.g., additional water) to the mixture. After solid particles have settled to the bottom of first cuttings storage vessel 1301, the solid particles of the mixture are pumped out of first cuttings storage vessel 1301 by pump 1304 through outlet line 1310. The extracted mixture may contain both a liquid component and a solid component. Those of ordinary skill in the art will appreciate that due to the separation of solid particles from the used drilling fluid in first cuttings storage vessel 1301, the mixture may initially include a higher concentration of solids component than liquid component. The mixture is pumped through valve 1305, which, as illustrated, allows for the direction of the pumped mixture to be selected between second cuttings storage vessel 1302 and drilling waste reservoir 1307.

Initially, the pumped mixture may contain a greater percentage of solids content due to the separation, as describe above. A desirable percentage of solid to liquid content may vary according to specific drilling operation requirements; however, those of ordinary skill the art will appreciate that in at least one embodiment, a desirable initial solid content of the pumped mixture may be greater than 50% by volume. As such, the pumped mixture including a desirable solid to liquid ratio for transfer to drilling waste reservoir 1307 will be hereinafter referred to as a positive mixture. In contrast, a pumped mixture including an undesirable solid to liquid ratio for transfer to drilling waste reservoir 1307 will be referred to as a negative mixture. Those of ordinary skill in the art will appreciate that in certain embodiments, to recycle drilling fluids efficiently, an acceptable positive condition may be 30% by volume solids, 50% by volume solids, 75% by volume solids, or any volume of solids as determined by a drilling operator. Likewise, acceptable negative conditions, wherein the mixture is pumped to second cuttings storage vessel 1302, may be appropriate when the mixture is 70% by volume liquid, 50% by volume liquid, 30% by volume liquid, or any volume as determined by a drilling operator to achieve a desired level of recycling efficiency.

As the pumped mixture is transferred through outlet line 1310, valve 1305 is actuated to provide fluid communication between first cuttings storage vessel 1301 and drilling waste reservoir 1307. The positive mixture may continue to be pumped to drilling waste reservoir 1307 until a negative mixture condition exists. Such a condition may occur when substantially all of the separated solids content from the mixture in first cuttings storage vessel 1301 is extracted.

To determine when such a condition exists, in one embodiment of the present disclosure, outlet line 1310 may be sufficiently translucent to allow a drilling operator to visually inspect and thereby determine an approximate solid to liquid ratio of the pumped mixture. Such visual inspection may rely on properties of the mixture such as color, viscosity, and flow rate. Upon determination of a negative condition, the drilling operator may either manually, or using automated assist means, actuate valve 1305 to change the direction of flow of the pumped mixture between first cuttings storage vessel 1301 and drilling waste reservoir 1307 to second cuttings storage vessel 1302.

Valve 1305 may be fluidly connected to second cuttings storage vessel 1302 via any of the connection means discussed above, including, for example, flexible hoses and/or existing piping. As valve 1305 is actuated to allow mixture from first cutting storage vessel 1301 to transfer to second cuttings storage vessel 1302, additional fluids, including water and/or chemical may be added to the mixture. Addition of such fluids may occur either during transfer of the mixture through line 1312 (i.e., inline), or after the mixture reaches second cuttings storage vessel 1302. In another embodiment, additional fluids may already exist in second cuttings storage vessel 1302 when the mixture is pumped thereto.

The mixture in second cuttings storage vessel 1302 may be allowed to further settle, or otherwise agitated using mechanical agitators (i.e., stirrers) or an inflow of fluids, as described above. Those of ordinary skill in the art will appreciate that the level of agitation, if agitation is used, will vary based on the specific properties of the mixture at the time such mixture is transferred to second storage vessel 1302. In at least one embodiment, such as in an embodiment using existing ISO-PUMPS, those of ordinary skill in the art will appreciate that no mechanical agitation means is used.

After sufficient separation of the mixture in second cuttings storage vessel 1302, the solution is transferred to filter system 1306. Filter system 1306 may include a number of different filters including, for example, hydrocarbon filters and filter presses, depending on the specific properties of the drilling fluid being processed. Those of ordinary skill in the art will appreciate that fluids containing substantially low levels of hydrocarbon content may merely be filtered through a hydrocarbon filter, while dense fluids including large amounts of solid matter may be filtered through a filter press, centrifuge, or other filter means. Upon completion of filtration, the cleaned fluid is transferred to cleaned fluid reservoir 1308. In certain embodiments, uncleaned fluid, including solids particulate matter or fluid containing high hydrocarbon levels may either be trapped in filter system 1306, transferred to drilling waste reservoir (not shown), or recycled to either first cuttings storage vessel 1301 or second cuttings storage vessel 1302 for further processing. Thus, in at least one embodiment, a cleaning loop may exist allowing for the substantially continuous processing of drilling fluids. In such a loop, cleaned fluids may be collected in a cleaned fluids reservoir 1308 for reuse in the drilling operation, while waste products may be separated and collected in the drilling waste reservoir 1307 for disposal or further remediation.

Referring to FIG. 17, a system 1400 for recycling drilling fluid in accordance with one embodiment of the present disclosure is shown. In this embodiment, system 1400 includes a first cuttings storage vessel 1401, a second cuttings storage vessel 1402, and a module 1403. Module 1403 includes a pump 1404, a valve 1405, a dosing tank 1413, a filter system 1406, and a plurality of control valves 1414. Valve 1405 provides for the control of fluid communication between first cuttings storage vessel 1401 and second cuttings vessel 1402 and/or drilling waste reservoir 1407. As described above, all structural elements including drilling waste reservoir 1407 and supply lines may be existing structures at a drilling location.

In this embodiment, drilling fluid is pumped or otherwise communicated from an upstream cleaning process into first cuttings storage vessel 1401 via a supply line 1409. In first cuttings storage vessel 1401, drilling fluid is mixed with additional water, as described above, or chemical additives to facilitate the precipitation and/or settling of solids particulates and material suspended within the drilling fluid. The additives and/or water may be added from dosing tank 1413, wherein such additives are mixed, stored, and/or added to first cuttings storage tank 1401 via, for example, an inline pump (not shown). As illustrated, the communication of additives from dosing tank 1413 to first cuttings storage tank 1401 is controlled by a control valve 1414, which may be, for example, a manual valve or an automated valve, and may be controlled through manual actuation or according to batch sequencing, as will be discussed in detail below.

The water and/or chemical additives added to the drilling fluid in first cuttings storage vessel 1401 may thereby promote the settling of solid material from the drilling fluid. When a desirable quantity of solid matter has separated to require a recycling operation, the settled positive mixture is pumped via pump 1404 through outlet line 1410 to primary valve 1405. As described above, primary valve 1405 controls the flow of the mixture between second cuttings storage vessel 1402 and drilling waste reservoir 1407. In certain embodiments, drilling waste reservoir 1407 may be substituted with a direct feed back to an upstream cleaning operation (e.g., to vibratory shakers) for additional cleaning.

When the mixture reaches a negative condition, primary valve 1405 directs the flow of the mixture to second cuttings storage vessel 1402 via line 1412. The mixture inside second cuttings storage vessel 1402 may be allowed to settle and/or separate further. Such separation may be facilitated by addition of chemicals, water, or agitation, as described above. After such separation occurs, the mixture is pumped and/or allowed to drain into filter system 1406. Filter system 1406 may include any of the types of filters described above, such as hydrocarbon filters and filter presses, for further removing hydrocarbons and/or solid particulate matter from the mixture. Upon completion of the filtration process, the cleaned fluid is directed to cleaned fluid reservoir 1408, and the remaining impurities (e.g., hydrocarbons and solid matter) may be trapped in filter system 1406, directed to drilling waste reservoir 1407, or otherwise collected for eventual disposal and/or further remediation. In this embodiment, cleaned fluid reservoir 1408 includes an outlet line 1415, which may be used to transfer the cleaned fluids to other operations on the rig. Such operations may include directing the cleaned fluids for use in drilling fluid mixing vessels, fluids used in the slurrification of cuttings for re-injection, fluids used for cleaning operations, or for other operations which require cleaned fluids at a drilling location.

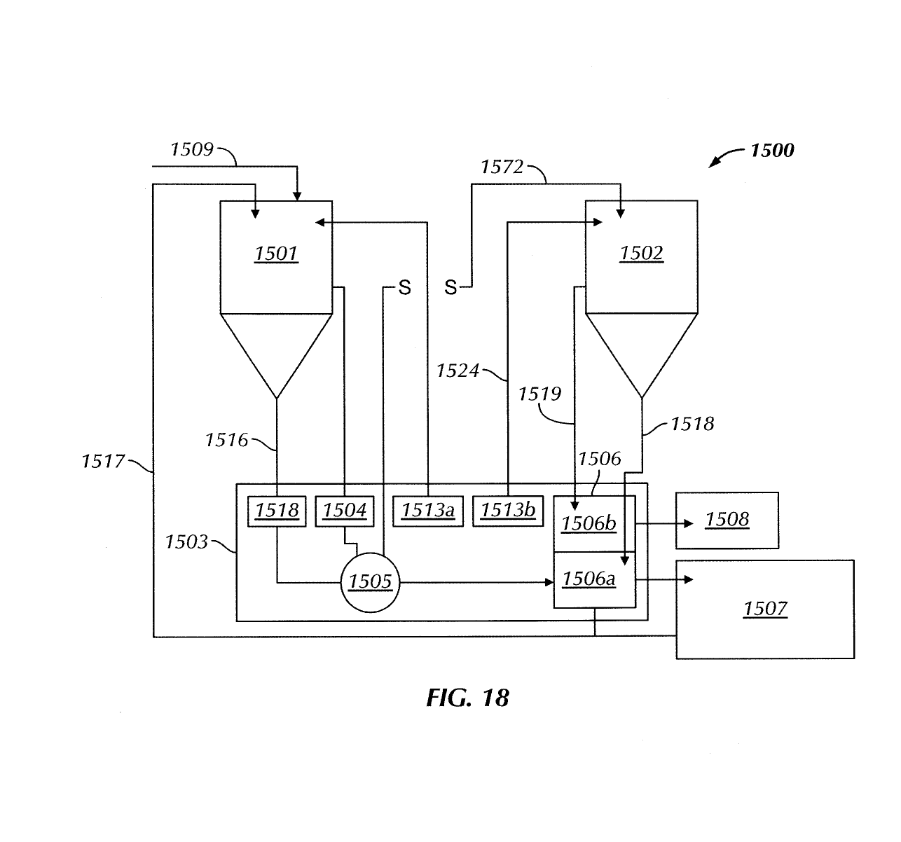

Referring now to FIG. 18, a system 1500 for recycling drilling fluid in accord with one embodiment of the present disclosure is shown. In this embodiment, system 1500 includes a first cuttings storage vessel 1501, a second cuttings storage vessel 1502, and a module 1503. Module 1503 includes a pump 1504, a valve 1505, dosing tanks 1513a and 1513b, and a filter system 1506. Valve 1505 provides for the control of fluid communication between first cuttings storage vessel 1501 and second cuttings vessel 1502 and/or drilling waste reservoir 1507. As described above, all structural elements including drilling waste reservoir 1507 and supply lines may be existing structures at a drilling location.

In this embodiment, a drilling fluid enters first cuttings storage vessel 1501 through a supply line 1509. The drilling fluid is allowed to separate in first cuttings storage vessel 1501 such that solid particles tend to settle toward the bottom of the vessel, while the less dense liquid phase of the drilling fluid separates toward the top of the vessel. This process may be facilitated by injecting chemical additives such as, for example, emulsion clearance agents from dosing tank 1513a into first cuttings storage vessel 1501. Examples of emulsion clearance agents that may be used in embodiments disclosed herein include, for example, anionic surfactants, nonionic surfactants, alkyl polyglycosides, and combinations thereof. Other chemical additives may be injected into first cuttings storage vessel 1501 including, for example, various surfactants and wettings agents, such as, fatty acids, soaps of fatty acids, amido amines, polyamides, polyamines, oleate esters, imidazoline derivatives, oxidized crude tall oil, organic phosphate esters, alkyl aromatic sulfates, sulfonates, and combinations thereof. Dosing of such chemical additives may vary according to the requirements of a given fluid recycling operation, however, those of ordinary skill in the art will appreciate that in certain embodiments, only minimal amounts of such additives may be used to achieve the desired result.

While drilling fluid separates in cuttings storage vessel 1501, the mixture may be agitated, as described above, or in certain embodiments using pressurized cuttings storage vessels, air may be injected into the mixture. The injected air may be controlled by a pneumatic control device (not shown) disposed on module 1503. In such an embodiment, an air line (not shown) from an air compressor (not shown) may be coupled to the pneumatic control device (not shown) on module 1503 to control a flow of air into first cuttings storage vessel 1501. Those of ordinary skill in the art will appreciate that air is only one additional example of a method to agitate the mixture in cuttings storage vessel 1501. Other methods may include stirring devices, water injection, chemical injection, heat, steam injection, or any other method of agitating a solution known in the art.

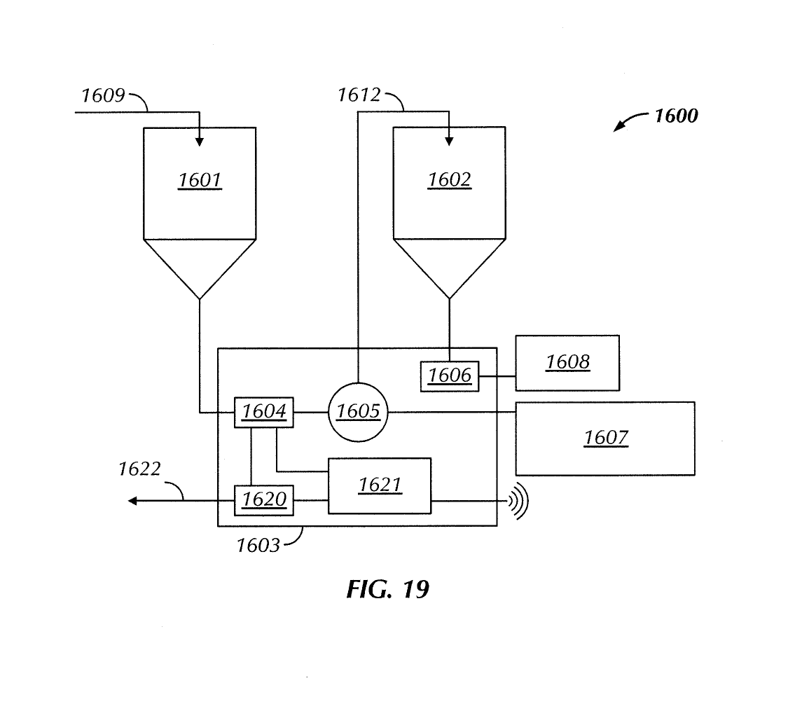

Still referring to FIG. 19, in this embodiment, when the mixture in cuttings storage vessel 1501 is separated to a desirable level, the solid cuttings waste that has collected toward the bottom of cuttings storage vessel 1501 is pumped out of the vessel via pump 1518 through line 1516. The mixture is then pumped through valve 1505, and if the mixture is in a positive condition, pumped directly to filter system 1506. In this embodiment, filter system 1506 is a compound filter module including a filter press 1506a and a hydrocarbon filter 1506b. The dense, generally solids component, may be further separated from any residual liquid phase, such that filter press 1506a directs the solids to drilling waste reservoir 1507, while directing any liquid phase back to cuttings storage vessel 1501 via a return line 1517. In certain embodiments, return line 1517 may be incorporated into module 1503, and the return of any such liquid phase from filter press 1506a to cuttings storage vessel 1501 may be facilitated with a pump (not shown).

When the mixture in first cuttings storage vessel 1501 reaches a negative condition, valve 1505 may be used to direct the mixture to cuttings storage vessel 1502 via line 1512. In this embodiment, a substantially liquid portion of the mixture in first cuttings storage vessel 1501, in a negative condition, may be pumped to second cuttings storage vessel 1502 for further processing by actuation of pump 1504, while valve 1505 directs the mixture through line 1512. As described above, should the condition of the mixture change (i.e., become positive), the mixture may be directed to filter press 1506a. In still other embodiments, those of ordinary skill in the art will appreciate that multiple valves similar to valve 1505 (e.g., R-valves), may be used to direct simultaneous flows of the mixture in first cuttings storage vessel 1501 to different components of system 1500, such as, for example, filter press 1506a, drilling waste reservoir 1507, or cuttings storage vessel 1502, at substantially the same time. Thus, in at least one embodiment, a valve system (not independently illustrated) may be foreseen that promotes the simultaneous processing of both positive and negative mixtures in first cuttings storage vessel 1501.

As the mixture is pumped via line 1524 into second cuttings storage vessel 1502, additional chemicals may be added to the mixture via a dosing tank 1513b. Examples of chemicals that may be added include anionic surfactants, nonionic surfactant, alkyl polyglycosides, wetting agents, surfactants, flocculants, and other chemicals that are known to those of skill in the art. Examples of the use of such chemical additives in a drilling fluid recycling system are described in U.S. Pat. Nos. 6,977,048 and 6,881,349, incorporated by reference in their entirety.

In system 1500, the mixture in second cuttings storage vessel 1502 may be further separated via chemical injection, as described above, through agitation, or through time-based separation. However, when separation occurs to a desirable level, the mixture may be removed from second cuttings storage vessel 1502 via line 1518. In this embodiment, the mixture in line 1518 may include a substantially solids mixture that may be in a positive condition, as described above, and as such, may be pumped into a filter press 1506a. Such a condition may exist in a system wherein chemical flocculant is injected into second cuttings storage vessel 1502, thereby creating flocs with a density greater than the mixture. However, in other embodiments, the solution in cuttings storage vessel 1502 is in a substantially positive condition, and solid sediment does not form. In such a system the mixture may be pumped from cuttings storage vessel 1502 into hydrocarbon filter 1506b, or may be pumped via an outlet in the side of second cuttings storage vessel 1502 through a secondary line 1519 to hydrocarbon filter 1506b. As described above, by providing a plurality of lines from second cuttings storage vessel 1502, the rate of drilling fluid processing may be increased.

Additional components for facilitating the removal of solid and oil components of the mixture may be added to system 1500 without departing from the scope of the present disclosure. Examples of such components may include hydrocyclones, centrifuges, and skimmers, which may be added as additional inline components during the direction of the mixture between first cuttings storage vessel 1501 and second cuttings storage vessel 1502 and components of module 1503. As such, those of ordinary skill in the art will appreciate that additional separation components may be added to module 1503, or may operate independent of module 1503, and still be considered a component of system 1500.

After the mixture is processed by filter system 1506, the cleaned drilling fluid is directed to cleaned fluid reservoir 1508. The fluids may then be collected and/or used in other portions of the drilling operation, as described above.

Referring to FIG. 16, a system 1600 for recycling drilling fluid according to one embodiment of the present disclosure is shown. In this embodiment, system 1600 includes a first cuttings storage vessel 1601, a second cuttings storage vessel 1602, and a module 1603. Module 1603 includes a pump 1604, a valve 1605, a filter system 1606, a power supply 1620, and a programmable logic controller (“PLC”) 1621. Valve 1605 provides for the control of fluid communication between first cuttings storage vessel 1601 and second cuttings vessel 1602 and/or drilling waste reservoir 1607. As described above, all structural elements including drilling waste reservoir 1607 and supply lines may be existing structures at a drilling location.

System 1600 works similarly to systems 1300, 1400, and 1500, described above. Briefly, a drilling fluid enters first cuttings storage vessel 1601 through supply line 1609. The fluid is allowed to separate, and is pumped via inline pump 1604 to valve 1605. If the mixture from first cuttings storage vessel 601 is in a positive condition, the mixture is sent to drilling waste reservoir 1607, or otherwise directed to a press filter (not independently illustrated) of filter system 1606. If the mixture is in a negative condition, the mixture is directed to second cuttings storage vessel 1602 via line 1612. After further separation in second cuttings storage vessel 1602, the fluid is transferred to filter system 1606 for the additional removal of residual solids and/or hydrocarbons. The cleaned fluid is then directed to a cleaned fluids reservoir 1608 for use in other drilling operations.

In this embodiment, system 1600 includes an independent power source 1620 for providing power to components of module 1603. Power source 1620 is electrically connected to, for example, pump 1604, valve 1605, filter system 1606, and/or PLC 1621. Those of ordinary skill in the art will appreciate that such a power source may provide primary or auxiliary power for powering components of module 1603. In other embodiments, power source 1620 may be merely an electrical conduit for connecting a power source on a rig (not shown) via an electrical cable 1622, to module 1603.

System 1600 also includes PLC 1621, operatively connected to, for example, pump 1604, valve 1605, and/or filter system 1606. In this embodiment, PLC 1621 provides instructions for controlling the rate of flow of the mixture of first cuttings storage vessel 1601 through valve 1605 to, for example, second cuttings storage vessel 1602. Controlling the rate of flow may include controlling the operation of pump 1604 or valve 1605. In one embodiment, PLC 1621 may provide for the automated control of valve 1605, directing the flow of the mixture from first cuttings storage vessel 1601 to second cuttings storage vessel 1602. Such control may occur as a result of valve 1605 including a sensor. Examples of such sensors may include density sensors, conductivity sensors, or other sensors known to those in the art for determining a condition of a drilling fluid, such as, a density. Such an embodiment may allow module 1603 to automatically control the speed of the recycling of the drilling fluid to obtain an optimal condition for a drilling operation. An optimal condition may include cleaning a drilling fluid to a determined level for use in the drilling operation. Those of ordinary skill in the art will appreciate that such a system may be used to reduce the hydrocarbon content of a fluid to less than, for example, 20 ppm, to meet environmental regulations defining the condition for disposable fluids. In other operations, the hydrocarbon content may be reduced to substantially 35 ppm, and the fluid may be used in other components of the drilling operation. Those of ordinary skill in the art will appreciate that such hydrocarbon levels are merely examples of how such a system 1600 may be used to clean and recycle drilling fluids.

Still referring to FIG. 19, PLC 1621 may provide for external communication of module 1603 with a rig management system. Rig management systems may include, on-rig systems used to control drilling operations, drill cuttings cleaning operations, environmental systems, and data collection systems. As such, PLC 1621 may record and/or analyze data such as time of drilling fluid recycling, the amount of drilling fluid recycled, the amounts of chemicals used in the operation of system 1600, power usage, and other data that may be used by a drilling operator to further increase the efficiency of the drilling operation. In still other embodiments, PLC 1621 may allow module 1603 to be operatively coupled with other modules to use the cleaned fluids of system 1600 to, for example, clean tanks, re-inject cuttings into a wellbore, create slurry, or further remediate drill cuttings and/or fluids.

To promote such interconnectivity, module 1603 may include a data communication device, such as, for example, a wireless access point 1623, thereby allowing module 1603 and/or system 1600 to communicate remotely with other systems, modules, rig management systems, or other remote communication devices known to those of skill in the art. Such an access point 1623 may further allow module 1603 to be controlled, or data acquired therefrom remotely.

Thermal Treatment

Thermal treatment processes separate and recovers hydrocarbon-based drilling fluids from used drilling fluids and other waste, in a closed loop, indirectly heated system. Hydrocarbons removed during desorption may then be re-used in the mud circulation system as there is no thermal degradation during the treatment. Operating on the principle of indirectly heated thermal desorption, hydrocarbons are volatized from solids in a closed chamber using controlled heat. Temperature levels and retention time in the chamber are closely monitored to ensure maximum phase separation without exceeding the fractionation point of the base oil. The desorbed vapors are then removed and rapidly condensed in a condensing system. The condensate is then divided into fractions using a specially engineered oil/water separator. Recovered base oil may then be collected, tested, and recycled as base fluid and/or used as fuel. Water is recovered and may be used to re-wet treated solids. The treated solids may then be disposed of. Examples of thermal treatment system are described in U.S. patent application Ser. No. 11/952,047, assigned to the assignee of the present application, and hereby incorporated by reference in its entirely.

Advantageously, embodiments of the present disclosure may provide for modular supply vessels capable of performing multiple processes for offshore drilling and production rigs. Because the supply vessels may include multiple modules for treating, remediating, and building drilling fluids, as well as modules for remediating, treating, and slurrifiying drilling waste, the supply vessels may be less expensive to maintain than traditional supply vessels. Additionally, because the components may be located below deck, the top surface of the vessel may remain uncluttered, thereby decreasing the risk of accidents, provide additional storage space, and allow for additional equipment to be transported. Also advantageously, embodiments of the present application may decrease the risk of injuries from crane lift accidents, as the components may allow for the pneumatic transference of materials between rigs, vessels, and onshore facilities.

Additionally, supply vessels according to embodiments of the present disclosure may allow for traditional shipment of drilling waste and materials, as waste or materials may be manually loaded or unloaded with cranes. The modularity of embodiments of the present application may thereby decrease the cost of drilling and production operations, increasing the overall profitability of the operations.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A multiple process service vessel comprising:
a first module configured to mix drilling fluids; and
a second module configured to remediate drilling waste;
wherein the first and second modules are located at least partially below the deck of the vessel.

2. The vessel of claim 1, further comprising:
at least one pressurized vessel in fluid communication with at least one of the first module and the second module.

3. The vessel of claim 2, wherein the first module comprises:
a mixer in fluid communication with the at least one pressurized vessel;
wherein the mixer is configured to receive a first drilling fluid component from the at least one pressurized vessel and mix the drilling fluid component with a second drilling fluid component.

4. The vessel of claim 3, wherein the first drilling fluid component comprises at least one of a base fluid and a weighting agent.

5. The vessel of claim 3, wherein the first module further comprises:
a surge tank in fluid communication with the at least one pressurized vessel; and
a hopper in fluid communication with the surge tank;
wherein the surge tank is configured to receive the first drilling fluid component from the at least one pressurized vessel and dispense the first drilling fluid component into the hopper.

6. The vessel of claim 2, wherein the second module comprises:
a first separator in fluid communication with the at least one pressurized vessel; and
a second separator in fluid communication with the first separator.

7. The vessel of claim 6, wherein the first separator comprises a centrifuge and the second separator comprises a thermal treatment unit.

8. The vessel of claim 6, wherein the second module further comprises:
a slurrification unit in fluid communication with the second separator;
wherein the slurrification unit is in fluid communication with at least one pressurized vessel.

9. The vessel of claim 2, further comprising:
an automatic tank cleaning unit in fluid communication with at least one pressurized vessel.

10. The vessel of claim 2, further comprising:
an environmental remediation unit configured to process slop water from drilling operations.

11. A multiple process service vessel comprising:
a plurality of pressurized vessels;
a first module in fluid communication with the plurality of pressurized vessels, the first module comprising:
a drilling fluid mixer;
a second module in fluid communication with the plurality of pressurized vessels, the second module comprising:
a drilling waste remediation unit;
a third module in fluid communication with the plurality of pressurized vessels, the third module comprising:
an automatic tank cleaning unit;
a fourth module in fluid communication with the plurality of pressurized vessels, the fourth module comprising:
an environmental remediation unit;
wherein the first, second, third, and fourth modules are located below a deck of the multiple process service vessel.

12. The vessel of claim 11, wherein the plurality of pressurized vessels is located below the deck of the multiple process service vessel.

13. A method of processing drilling components, the method comprising:
transferring a first drilling fluid component from a pressurized vessel on a multiple process service vessel to a mixing unit at a first location;
mixing the first drilling fluid component with a second drilling fluid component in the mixing unit to produce a drilling fluid;
transferring the drilling fluid to a second pressurized vessel;
moving the multiple process service vessel to a second location; and
transferring the drilling fluid from the second pressurized vessel to a drilling location.

14. The method of claim 13, further comprising:
cleaning the second pressurized vessel;
recovering fluids from the second pressurized vessel produced during the cleaning; and
remediating the recovered fluids, wherein the remediating comprises separating the recovered fluids into a water portion and a contaminant portion.

15. The method of claim 14, further comprising:
reusing the water portion in a second drilling fluid.

16. A method of processing drilling components, the method comprising:
transferring drilling waste from a drilling location to a multiple process service vessel;
processing the drilling waste into a fluid component and a waste component;
adjusting at least one property of the fluid component; and
transferring the fluid component to a storage vessel on the multiple process service vessel.

17. The method of claim 16, further comprising:
transferring the fluid component from the storage vessel to a drilling location.

18. The method of claim 17, further comprising:
cleaning the storage vessel;
recovering fluids from the storage vessel produced during the cleaning; and
remediating the recovered fluids, wherein the remediating comprises separating the recovered fluids into a water portion and a contaminant portion.

19. The method of claim 18, further comprising:
storing the water portion in a second storage vessel; and
using the water portion in a subsequent cleaning cycle.
